(19) United States
(12) Patent Application Publication
(10) Pub. No.: US 2025/0055412 A1
(43) Pub. Date: Feb. 13, 2025

(54) MOUNTING DEVICE TO SELECTIVELY SECURE A MODULE-LEVEL POWER ELECTRONICS DEVICE TO A FRAME OF A PHOTOVOLTAIC ASSEMBLY

(71) Applicant: RMH Tech LLC, Colorado Springs, CO (US)

(72) Inventor: Jonathon Moss, Grandview, TX (US)

(21) Appl. No.: 18/798,389

(22) Filed: Aug. 8, 2024

Related U.S. Application Data
(60) Provisional application No. 63/581,170, filed on Sep. 7, 2023.
(60) Provisional application No. 63/518,792, filed on Aug. 10, 2023.

(51) Int. Cl. H02S 30/10; F16M 13/02

(52) U.S. Cl. CPC H02S 30/10; F16M 13/02

(57) ABSTRACT

A mounting device selectively engageable to a module-level power electronics (MLPE) device includes a body with an aperture, a first arm, and a second arm. The first arm extends from a first side of the body at a first arm angle relative to the body. The second arm extends from a second side of the body at a second arm angle relative to the body. When the aperture receives a fastener able to engage an extension of the MLPE, the first arm makes contact with a first surface of a frame section of a photovoltaic (PV) frame and holds the extension against a second surface of the frame section, securing the PV frame to the extension via the interconnecting mounting device. The first arm may include teeth operable to engage the frame section. The mounting device may include a tab operable to engage the extension.

### CROSS-REFERENCE TO RELATED APPLICATIONS

This application claims the benefit of priority under 35 U.S.C. § 119 (c) to U.S. Provisional Patent Application No. 63/581,170, filed on Sep. 7, 2023; and to U.S. Provisional Patent Application No. 63/518,792, filed on Aug. 10, 2023; the entirety of each of which is incorporated herein by reference.

### FIELD

The present disclosure relates to mounting devices or brackets configured to secure a module-level power electronics device or other components to a frame of a photovoltaic module or other external structure such as a metal panel defining a roof or a sidewall of a building.

### BACKGROUND

Module-level power electronics (MLPE) are devices used with solar photovoltaic systems (PV systems). An MLPE device can improve the operational capabilities of the PV systems by mitigating production losses that may be caused by factors such as shading, mismatched PV components of the PV system, differences in orientation and/or slope of those PV components when installed on one or more ground surfaces or roof surfaces, and the like.

MLPE devices are frequently connected to solar panels of the PV systems that are installed on metal panels, particularly metal panels used to form a roof. During construction, adjacent metal panels are connected at seamed joints, which are weatherproof and protect the building from the external environment. The seamed joints may have many different configurations, including a single fold, double fold, snap seam, snap lock, nail strip, batten cap, T-scam, and bulb scam. In addition, some metal panels have ribs that extend from the panel. The ribs are positioned between seams that join the metal panel to adjacent metal panels.

Mounting devices or clamps are used to mount the solar panels to the metal panels. Typically, a clamp is secured to a fold, a joint or a seam between two metal panels or to a rib extending from a metal panel (collectively referred to herein as “a panel projection”) without puncturing the metal panel. Clamps are available to engage panel projections of different shapes and sizes. Examples of known clamps and PV mounting systems are described in U.S. Patent App. Pub. 2014/0311087, U.S. Patent App. Pub. 2015/0247326, U.S. Patent App. Pub. 2018/003127, and U.S. Patent App. Pub. 2019/0296689 which are each incorporated herein by reference in their entirety. Some clamps can be secured to the roof by squeezing or clamping to the panel projection that extends away from the roof. Other clamps or brackets are secured to the panel projections by fasteners that extend through the panel projection. Once the clamp engages the panel projection, a structure such as a solar panel (or, more specifically, the frame of the solar panel) may then be connected to the clamp.

In some PV systems, electronics and wires are routed through rails between the solar panels, and exterior modules may optionally be positioned elsewhere on the roof or building. Where a PV system does not include the rails for the routing of electronics and wires, and/or where a more compact configuration is desired, an alternative solution is necessary to consolidate the electronics instead of running the wires along the underside of the solar panel or securing the electronics and wires to the mounting surface of the roof.

### SUMMARY

Accordingly, there is a need for a mounting device or bracket for an MLPE device that is selectively engageable to the MLPE device and a frame of a PV module. The MLPE device should be securable to the frame via the mounting device, such that the MLPE is positioned underneath a solar panel and optionally raised above the mounting surface of a building. The mounting device should be retrofittable to existing MLPE devices. The mounting device or bracket should be economical to produce.

Aspects of the present disclosure include a mounting device selectively engageable to an MLPE device or other components of a PV system. The mounting device includes a body, a first arm, and a second arm. The body has an aperture. The first arm extends from a first side of the body at a first arm angle relative to a surface of the body. The second arm extends from a second side of the body at a second arm angle relative to the surface of the body. When the aperture receives a fastener able to engage an extension of the MLPE, the first arm makes contact with a first surface of a frame section of a PV frame of the PV system and holds the extension of the MLPE or other component against a second surface of the frame section, securing the PV frame between the first arm and the extension. The first arm may include teeth operable to engage the frame section. In some instances, the teeth may cut through an anodized layer of the PV frame to increase an amount of bonding and/or grounding between the PV frame, the mounting device, and the MLPE. The second arm may include a tab operable to engage the extension. In some instances, the tab may prevent rotation of the mounting device relative to the extension while the fastener is inserted into the aperture and the extension of the MLPE.

An aspect of the disclosure is a mounting device that is selectively engageable to an MLPE device or other component of a PV system. The mounting device comprises: (1) a body including an aperture operable to receive a fastener able to engage an extension of the MLPE device or other component; (2) a first arm extending from a first side of the body, the first arm extending at a first arm angle relative to a surface of the body; and (3) a second arm extending from a second side of the body, the second arm extending at a second arm angle relative to the surface of the body. When the aperture receives the fastener, the first arm is operable to make contact with a first surface of a frame section of a PV frame of the PV system and hold the extension of the MLPE device or other component against a second surface of the frame section, securing the PV frame within a gap defined between the first arm and the extension of the MLPE device or other component.

In some embodiments, the body further comprises a neck and the aperture extends through the neck. In some embodiments, the aperture is at least partially threaded with interior threading that corresponds to exterior threading on a shaft of the fastener.

In some embodiments, the aperture extends along an aperture axis that is approximately perpendicular to the surface of the body.

In some embodiments, the first arm includes a plurality of teeth operable to engage the first surface of the frame section.

In some embodiments, the mounting device further comprises a tab extending at a tab angle relative to the surface of the body. The tab is operable to engage a cutout (or slot) through the extension of the MLPE device or other component. In some embodiments, the tab is formed from a section of the second arm. In some embodiments, the second arm is separated into first and second portions by the formation of the tab. In some embodiments, the tab angle is different from one or more of the first arm angle and the second arm angle. In some embodiments, the tab angle is less than one or more of the first arm angle and the second arm angle. In some embodiments, the tab angle is approximately 90 degrees.

In some embodiments, the first arm angle and the second arm angle are approximately the same. Alternatively, in at least one embodiment, the first arm angle and the second arm angle are different.

In at least one embodiment, one or more of the first arm angle and the second arm angle are between approximately 125 and 160 degrees relative to the surface of the body. Optionally, at least one of the first arm angle and the second arm angle is approximately 135 degrees relative to the surface of the body, or approximately 45 degrees below a horizontal plane defined by the surface of the body.

In one or more embodiments, the first arm angle is between approximately 85 degrees and approximately 140 degrees relative to the surface of the body. Optionally, the first arm angle is approximately 90 degrees below a horizontal plane defined by the surface of the body.

In some embodiments, the second arm angle is between approximately 130 degrees and approximately 160 degrees relative to the surface of the body. Optionally, the second arm angle is approximately 150 degrees relative to the body, or approximately 30 degrees below a horizontal plane defined by the surface of the body.

The first arm has a first height and the second arm has a second height. In some embodiments, the first height is different than the second height. Optionally, the first height is less than the second height.

In some embodiments, the PV frame is secured within the gap defined between the first arm and the extension of the MLPE device when a nut is threaded onto the fastener after the aperture receives the fastener. In these embodiments, the aperture may be threaded or unthreaded.

Another aspect of the present disclosure is a mounting system that is selectively engageable to a PV frame and an electrical component of a PV system. The mounting system comprises: (1) a fastener including a head and a shaft, where the fastener is able to engage an extension of the electrical component; and (2) a bracket. The bracket comprises: (a) a body including an aperture operable to receive the shaft of the fastener; (b) a first arm extending from a first side of the body, the first arm extending at a first arm angle relative to a surface of the body; and (c) a second arm extending from a second side of the body, the second arm extending at a second arm angle relative to the surface of the body. When the aperture receives the shaft of the fastener, the first arm is operable to make contact with a first surface of a frame section of the PV frame and hold the extension of the electrical component against a second surface of the frame section, securing the PV frame within a gap defined between the first arm and the extension of the electrical component.

In some embodiments, the electrical component is an MLPE device.

In some embodiments, the aperture extends through a neck extending from the surface of the body. In some embodiments, the aperture is at least partially threaded with interior threading that corresponds to exterior threading on at least a portion of the shaft of the fastener.

In some embodiments, the aperture extends along an aperture axis that is approximately perpendicular to the surface of the body.

In some embodiments, the first arm includes a plurality of teeth operable to engage the first surface of the frame section.

In some instances, the teeth may cut through an anodized layer of the PV frame to increase an amount of bonding and/or grounding between the PV frame, the mounting device, and the electrical component.

In some embodiments, the second arm includes a tab extending at a tab angle relative to the surface of the body. The tab is operable to engage a cutout (or slot) in the extension of the electrical component. In some instances, the tab may prevent rotation of the mounting device relative to the extension while the fastener is inserted into the aperture and the extension of the electrical component.

In some embodiments, the mounting system includes a nut with interior threading that corresponds to exterior threading on at least a portion of the shaft of the fastener. The PV frame is secured within the gap defined between the first arm and the extension of the electrical component when the nut is threaded onto the fastener after the aperture receives the fastener. In these embodiments, the aperture may be threaded or unthreaded.

Another aspect of the present disclosure is a PV system. The PV system comprises: (1) a PV frame operable to receive a solar panel, where the PV frame includes a frame section; (2) an electrical component, where the electrical component includes an extension; (3) a fastener including a head and a shaft, wherein the shaft is able to extend through the extension of the electrical component; and (4) a bracket. The bracket comprises: (a) a body including an aperture operable to receive the shaft of the fastener; (b) a first arm extending from a first side of the body, the first arm extending at a first arm angle relative to a surface of the body; and (c) a second arm extending from a second side of the body, the second arm extending at a second arm angle relative to the surface of the body. When the aperture receives the shaft of the fastener, the first arm is operable to make contact with a first surface of the frame section of the PV frame and hold the extension of the electrical component against a second surface of the frame section of the PV frame, securing the PV frame to extension of the electrical component.

In some embodiments, the electrical component is a module-level power electronics (MLPE) device or the like.

In some embodiments, the first arm angle is approximately equivalent to the second arm angle. In some embodiments, the first arm angle is different from the second arm angle.

In some embodiments, the aperture extends along an aperture axis that is approximately perpendicular to the surface of the body.

In some embodiments, the aperture axis is approximately parallel to one or more of the first arm and the tab.

Another aspect of the present disclosure is directed to a mounting device that is selectively engageable to a component of a photovoltaic system. The mounting device includes a body including an aperture operable to receive a fastener that is able to engage an extension of the component; a first arm extending from a first side of the body, the first arm extending at a first arm angle relative to a surface of the body; and a second arm extending from a second side of the body, the second arm extending at a second arm angle relative to the surface of the body. When the aperture receives the fastener, the first arm is operable to make contact with a first surface of a frame section of a photovoltaic (PV) frame of the photovoltaic system and hold the extension of the component against a second surface of the frame section, securing the PV frame within a gap defined between the first arm and the extension of the component.

In some embodiments, the aperture extends through a neck extending from the surface of the body. Optionally, the aperture is at least partially threaded with interior threading that corresponds to exterior threading on at least a portion of a shaft of the fastener.

In some embodiments, the aperture extends along an aperture axis that is approximately perpendicular to the surface of the body.

In some embodiments, the first arm includes a plurality of teeth operable to engage the first surface of the frame section,

In some embodiments, the mounting device further comprising a tab extending from the body at a tab angle relative to the surface of the body, the tab being operable to engage a cutout through the extension of the component. Optionally, the tab is formed from a section of the second arm. In addition, the second arm is optionally separated into first and second portions by the tab. Optionally, the tab angle is different from one or more of the first arm angle and the second arm angle. In addition, the tab angle is optionally less than one or more of the first arm angle and the second arm angle. In some instances, the tab angle is approximately 90 degrees, the first arm angle is between 85 degrees and 140 degrees, and the second arm angle is between 125 degrees and 160 degrees.

In some embodiments, the PV frame is secured within the gap defined between the first arm and the extension of the component when the aperture receives the fastener.

In some embodiments, the component is a module-level power electronics device (MLPE).

Another aspect of the present disclosure is directed to a mounting system that is selectively engageable to a photovoltaic (PV) frame and a component of a photovoltaic system. The mounting system includes a fastener including a head and a shaft, the fastener being able to engage an extension of the component; and a bracket. The bracket includes a body including an aperture operable to receive the shaft of the fastener; a first arm extending from a first side of the body, the first arm including a plurality of teeth, the first arm extending at a first arm angle relative to a surface of the body; and a second arm extending from a second side of the body, the second arm extending at a second arm angle relative to the surface of the body. When the aperture receives the shaft of the fastener, the first arm is operable to make contact with a first surface of a frame section of the PV frame and hold the extension of the component against a second surface of the frame section, securing the PV frame within a gap defined between the first arm and the extension of the component.

In some embodiments, the aperture extends through a neck extending from the surface of the body. Optionally, the aperture is at least partially threaded with interior threading that corresponds to exterior threading on at least a portion of the shaft of the fastener.

In some embodiments, the aperture extends along an aperture axis that is approximately perpendicular to the surface of the body.

In some embodiments, the first arm angle is approximately 90°.

In some embodiments, the bracket further comprises a tab extending at a tab angle relative to the surface of the body, the tab being operable to engage a cutout in the extension of the component.

In some embodiments, the tab angle is approximately 90°.

In some embodiments, the mounting system further includes a nut including interior threading that corresponds to exterior threading on at least a portion of the shaft of the fastener. The PV frame is secured within the gap defined between the first arm and the extension of the component when the nut is threaded onto the fastener after the shaft of the fastener extends through the aperture and a cutout in the extension of the component.

In some embodiments, the component is a module-level power electronics device (MLPE).

Another aspect of the present disclosure is directed to a photovoltaic (PV) system. The PV system includes a PV frame operable to receive a solar panel, the PV frame including a frame section; a module-level power electronics device (MLPE), the MLPE including an extension with a cutout; a fastener including a head and a shaft, the shaft being able to extend through the cutout of the extension of the MLPE; and a bracket. The bracket includes a body including an aperture operable to receive the shaft of the fastener; a first arm extending from a first side of the body, the first arm extending at a first arm angle relative to a surface of the body; and a second arm extending from a second side of the body, the second arm extending at a second arm angle relative to the surface of the body. When the shaft extends through the cutout and the aperture receives the shaft, the first arm is operable to make contact with a first surface of the frame section of the PV frame and hold the extension of the MLPE against a second surface of the frame section of the PV frame, securing the PV frame to the extension of the MLPE and electrically bonding the frame section and the MLPE.

Another aspect of the present disclosure is directed to a mounting device that is selectively engageable to a component of a photovoltaic system. The mounting device includes a body including an aperture operable to receive a fastener that is able to engage an extension of the component, the aperture extending through a neck extending from a surface of the body, and the aperture being at least partially threaded with interior threading that corresponds to exterior threading on at least a portion of a shaft of the fastener; a first arm extending from a first side of the body, the first arm including a plurality of teeth, the first arm extending at a first arm angle relative to the surface of the body; a second arm extending from a second side of the body, the second arm extending at a second arm angle relative to the surface of the body; and a tab extending at a tab angle relative to the surface of the body, the tab being operable to engage a cutout through the extension of the component. When the aperture receives the fastener, the plurality of teeth of the first arm is operable to make contact with a first surface of a frame section of a photovoltaic (PV) frame of the photovoltaic system and hold the extension of the component against a second surface of the frame section, securing the PV frame within a gap defined between the first arm and the extension of the component.

In some embodiments, the first arm is connected to the first side of the body by a first bend.

In some embodiments, the second arm is connected to the second side of the body by a second bend.

In some embodiments, the tab extends from the second side of the body.

In some embodiments, the tab is formed from a section of the second arm. Optionally, the second arm is separated into first and second portions by the tab.

In some embodiments, the tab angle is different from one or more of the first arm angle and the second arm angle.

Optionally, the tab angle and the first arm angle are such that the tab and the first arm are approximately parallel, and the second arm angle being different from the tab angle and the first arm angle.

Optionally, the tab angle is less than one or more of the first arm angle and the second arm angle.

In some examples, the tab angle is approximately 90 degrees, the first arm angle is between 85 degrees and 140 degrees, and the second arm angle is between 125 degrees and 160 degrees. In some instances, the tab angle may be approximately 90 degrees, the first arm angle may be approximately 90 degrees; and the second arm angle may be approximately 150 degrees.

In other examples, the tab angle is approximately 90 degrees, the first arm angle is between 85 degrees and 140 degrees, and the second arm angle is between 85 degrees and 140 degrees. In some instances, the tab angle is approximately 90 degrees, the first arm angle is approximately 135 degrees, and the second arm angle is approximately 135 degrees.

The aperture extends along an aperture axis, and in at least some embodiments, the aperture axis is oriented at an axis angle of between about 80° and about 100° to the surface of the body.

In at least one embodiment, the axis angle is approximately 90° to the surface of the body.

In some embodiments, the aperture axis is parallel to at least one of the first arm and the tab.

In some embodiments, the first arm has a first thickness that is substantially equal to a second thickness of the second arm.

In some embodiments, the body has a third thickness that is substantially equal to the first thickness of the first arm.

In some embodiments, the neck has a first height that is greater than the third thickness of the body.

In some embodiments, the PV frame is secured within the gap defined between the first arm and the extension of the component when the aperture receives the fastener.

In some embodiments, the component is a module-level power electronics device (MLPE).

The mounting device optionally includes one or more of the previous embodiments, and in some embodiments the body is formed of a metallic material such that the mounting device electrically bonds the component to the frame section of the photovoltaic frame.

Another aspect of the present disclosure is directed to a mounting system that is selectively engageable to a photovoltaic (PV) frame and a component of a photovoltaic system. The mounting system includes a fastener including a head and a shaft, the fastener being able to engage an extension of the component; and a bracket. The bracket includes a body including an aperture operable to receive the shaft of the fastener, the aperture extending through a neck extending from a surface of the body, and the aperture being at least partially threaded with interior threading that corresponds to exterior threading on at least a portion of the shaft of the fastener; a first arm extending from a first side of the body, the first arm including a plurality of teeth, the first arm extending at a first arm angle relative to the surface of the body; a second arm extending from a second side of the body, the second arm extending at a second arm angle relative to the surface of the body; and a tab extending at a tab angle relative to the surface of the body, the tab being operable to engage a cutout through the extension of the component. When the aperture receives the shaft of the fastener, the plurality of teeth of the first arm is operable to make contact with a first surface of a frame section of the PV frame and hold the extension of the component against a second surface of the frame section, securing the PV frame within a gap defined between the first arm and the extension of the component.

In some embodiments, the tab is formed from a section of the second arm, and the second arm is separated into first and second portions by the tab.

In some embodiments, the tab angle is different from one or more of the first arm angle and the second arm angle.

Optionally, the tab angle is less than one or more of the first arm angle and the second arm angle. In some examples, the tab angle is approximately 90 degrees, the first arm angle is between 85 degrees and 140 degrees, and the second arm angle is between 125 degrees and 160 degrees.

In other examples, the tab angle is approximately 90 degrees, the first arm angle is between 85 degrees and 140 degrees, and the second arm angle is between 85 degrees and 140 degrees.

In some embodiments, the PV frame is secured within the gap defined between the first arm and the extension of the component when the aperture receives the fastener.

In some embodiments, the component is a module-level power electronics device (MLPE).

Another aspect of the present disclosure is directed to a photovoltaic (PV) system. The PV system includes a PV frame operable to receive a solar panel, the PV frame including a frame section; a module-level power electronics device (MLPE), the MLPE including an extension with a cutout; a fastener including a head and a shaft, the shaft being able to extend through the cutout of the extension of the MLPE; and a bracket. The bracket includes a body including an aperture operable to receive the shaft of the fastener, the aperture extending through a neck extending from a surface of the body, and the aperture being at least partially threaded with interior threading that corresponds to exterior threading on at least a portion of the shaft of the fastener; a first arm extending from a first side of the body, the first arm including a plurality of teeth, the first arm extending at a first arm angle relative to the surface of the body; a second arm extending from a second side of the body, the second arm extending at a second arm angle relative to the surface of the body; and a tab extending at a tab angle relative to the surface of the body, the tab being operable to extend at least partially into the cutout through the extension of the MLPE. When the aperture receives the fastener, the plurality of teeth of the first arm is operable to make contact with a first surface of the frame section of the PV frame and hold the extension of the MLPE against a second surface of the frame section of the PV frame, securing the PV frame to the extension of the MLPE.

In some embodiments, a mounting device or bracket as described throughout the present disclosure is formed via a series of fabrication processes through a progressive die. For example, the fabrication processes may include, but are not limited to, one or more stamping processes, one or more bending processes, one or more punching processes, one or more necking processes, one or more tapping processes, and/or other processes that are simultaneously, substantially simultaneously, or sequentially performed as a section of a coil roll passes through the progressive die to form the bracket from an initial portion of sheet metal from the section of the coil roll. By way of another example, the bracket is formed from a metal such as a stainless steel or, in general, a metal with increased corrosion resistance and increased strength as compared to an aluminum subjected to one or more extrusion processes.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. When used with a number or a range, the terms “about” and “approximately” indicate the number or range may be “a little above” or “a little below” the endpoint with a degree of flexibility as would be generally recognized by those skilled in the art. Further, the terms “about” and “approximately” may include the exact endpoint, unless specifically stated otherwise. Accordingly, unless otherwise indicated, all numbers expressing quantities, dimensions, conditions, ratios, angles, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 10% of the stated value.

The term “parallel” means two objects are oriented at an angle within plus or minus 0° to 5° unless otherwise indicated. Similarly, the term “perpendicular” means two objects are oriented at angle of from 85° to 95° unless otherwise indicated.

Unless otherwise indicated, the term “substantially” indicates a difference of from 0% to 5% of the stated value is acceptable.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1A is a top perspective view of a photovoltaic (PV) system including a mounting device for a module-level power electronics (MLPE) device, according to embodiments of the present disclosure;

FIG. 1B is a top perspective view of the PV system of FIG. 1A, with the mounting device and the MLPE device in an exploded configuration;

FIG. 1C is a front elevation view of the PV system of FIG. 1A;

FIG. 1D is a front elevation view of a variation of the PV system of FIG. 1A;

FIG. 1E is a top plan view of the PV system of FIG. 1A;

FIG. 1F is a bottom plan view of the PV system of FIG. 1A;

FIG. 2A is a front, top perspective view of a mounting device for an MLPE device in a PV system, according to embodiments of the present disclosure;

FIG. 2B is a front, bottom perspective view of the mounting device of FIG. 2A;

FIG. 2C is a front elevation view of the mounting device of FIG. 2A;

FIG. 2D is a rear elevation view of the mounting device of FIG. 2A;

FIG. 2E is a right side elevation view of the mounting device of FIG. 2A;

FIG. 2F is a left side elevation view of the mounting device of FIG. 2A;

FIG. 2G is a top plan view of the mounting device of FIG. 2A;

FIG. 2H is a bottom plan view of the mounting device of FIG. 2A;

FIG. 3A is a front, top perspective view of a mounting device for an MLPE device in a PV system, according to embodiments of the present disclosure;

FIG. 3B is a front, bottom perspective view of the mounting device of FIG. 3A;

FIG. 3C is a front elevation view of the mounting device of FIG. 3A;

FIG. 3D is a rear elevation view of the mounting device of FIG. 3A;

FIG. 3E is a right side elevation view of the mounting device of FIG. 3A;

FIG. 3F is a left side elevation view of the mounting device of FIG. 3A;

FIG. 3G is a top plan view of the mounting device of FIG. 3A;

FIG. 3H is a bottom plan view of the mounting device of FIG. 3A;

FIG. 4A is a front, top perspective view of a mounting device for an MLPE device in a PV system, according to embodiments of the present disclosure;

FIG. 4B is a front, bottom perspective view of the mounting device of FIG. 4A;

FIG. 4C is a front elevation view of the mounting device of FIG. 4A;

FIG. 4D is a rear elevation view of the mounting device of FIG. 4A;

FIG. 4E is a right side elevation view of the mounting device of FIG. 4A;

FIG. 4F is a left side elevation view of the mounting device of FIG. 4A;

FIG. 4G is a top plan view of the mounting device of FIG. 4A;

FIG. 4H is a bottom plan view of the mounting device of FIG. 4A;

FIG. 4I is a front elevation view of a PV system including the mounting device of FIG. 4A for an MLPE device;

FIG. 5 is a right side elevation view of a mounting device for an MLPE device in a PV system, according to embodiments of the present disclosure;

FIG. 6 is a left side elevation view of a mounting device for an MLPE device in a PV system, according to embodiments of the present disclosure;

FIG. 7A is a front, top perspective view of a mounting device for an MLPE device in a PV system, according to embodiments of the present disclosure;

FIG. 7B is a front, bottom perspective view of the mounting device of FIG. 7A;

FIG. 7C is a front elevation view of the mounting device of FIG. 7A;

FIG. 7D is a rear elevation view of the mounting device of FIG. 7A;

FIG. 7E is a right side elevation view of the mounting device of FIG. 7A;

FIG. 7F is a left side elevation view of the mounting device of FIG. 7A;

FIG. 7G is a top plan view of the mounting device of FIG. 7A;

FIG. 7H is a bottom plan view of the mounting device of FIG. 7A;

FIG. 8A is a front, top perspective view of a mounting device for an MLPE device in a PV system, according to embodiments of the present disclosure;

FIG. 8B is a front, bottom perspective view of the mounting device of FIG. 8A;

FIG. 8C is a front elevation view of the mounting device of FIG. 8A;

FIG. 8D is a rear elevation view of the mounting device of FIG. 8A;

FIG. 8E is a right side elevation view of the mounting device of FIG. 8A;

FIG. 8F is a left side elevation view of the mounting device of FIG. 8A;

FIG. 8G is a top plan view of the mounting device of FIG. 8A;

FIG. 8H is a bottom plan view of the mounting device of FIG. 8A; and

FIG. 8I is a front elevation view of a PV system including the mounting device of FIG. 8A for an MLPE device.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

In the following description of various embodiments, components of mounting devices of different embodiments are identified by the same reference numbers. Those corresponding components between two embodiments that different in at least some respect are identified by the same reference number, but may include suffix such as a letter (e.g., 4 versus 4A, etc.).

The following is a listing of components according to various embodiments of the present disclosure, and as shown in the drawings:

| Number | Component |
|---|---|
| 2 | Photovoltaic (PV) system |
| 3 | Mounting system |
| 4 | Mounting device or bracket |
| 6 | Module-level power electronics (MLPE) device |
| 7 | Head |
| 8 | Fastener |
| 9 | Shaft |
| 10 | Aperture |
| 11 | Shaft diameter |
| 12 | Cutout or slot |
| 14 | Extension |
| 16 | Gap |
| 18 | Frame section |
| 20 | PV frame |
| 21 | Solar panel |
| 22 | First PV frame surface |
| 24 | Second PV frame surface |
| 26 | Tab |
| 28 | Cutout curve |
| 30 | Body |
| 32 | Neck |
| 34 | First arm |
| 36 | Teeth |
| 37 | Second arm portion |
| 38 | Second arm |
| 39 | Second arm portion |
| 40 | Total length |
| 42 | Total width |
| 44 | Tab height |
| 46 | Aperture length |
| 48 | Aperture width |
| 50 | Edge |
| 51 | First arm bend |
| 52 | Second arm bend |
| 54 | Tab length |
| 56 | Neck height |
| 58 | First arm height |
| 60 | Second arm height |
| 62 | First arm angle |
| 64 | Second arm angle |
| 66 | Tab angle |
| 68 | Body surface |
| 70 | Trough length |
| 72 | Fastener receiver |
| 74 | First arm surface |
| 76 | Second arm surface |
| X | Lateral dimension |
| Y | Longitudinal dimension |
| Z | Vertical or Height dimension |

### DETAILED DESCRIPTION

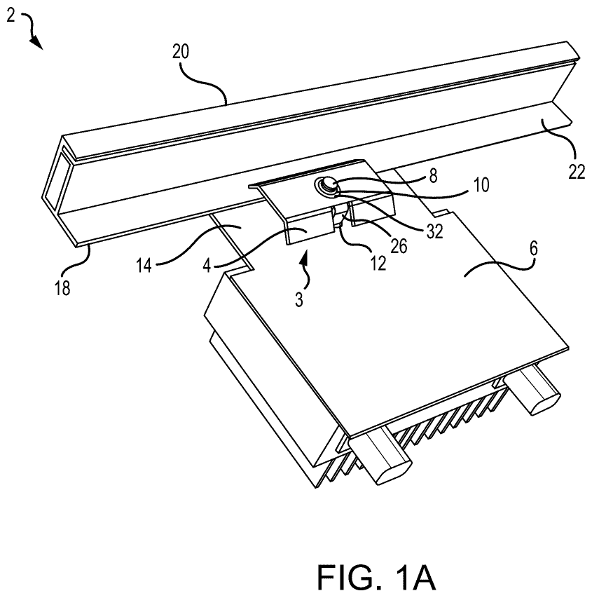

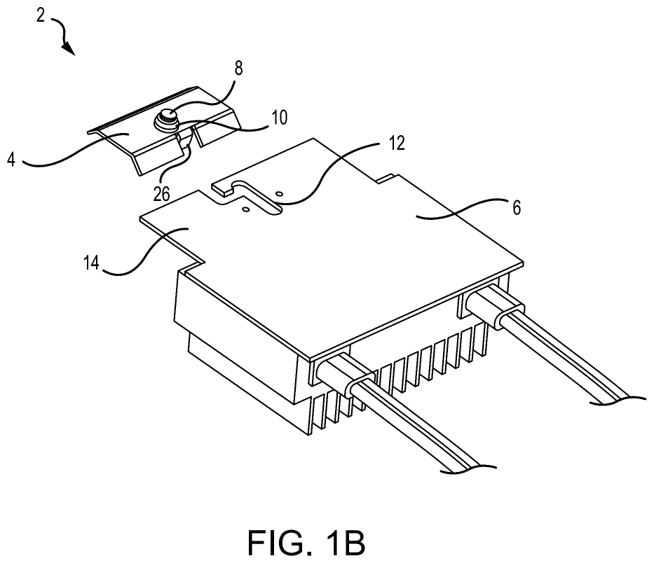

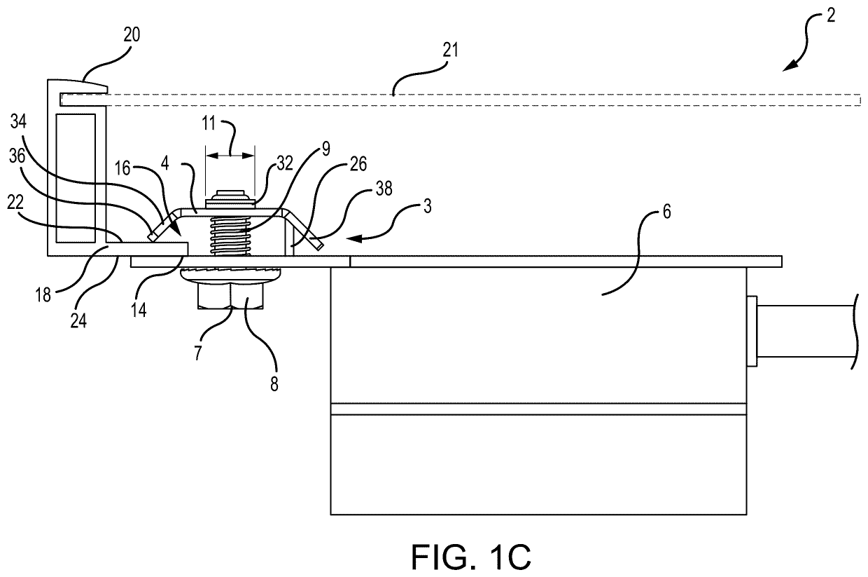

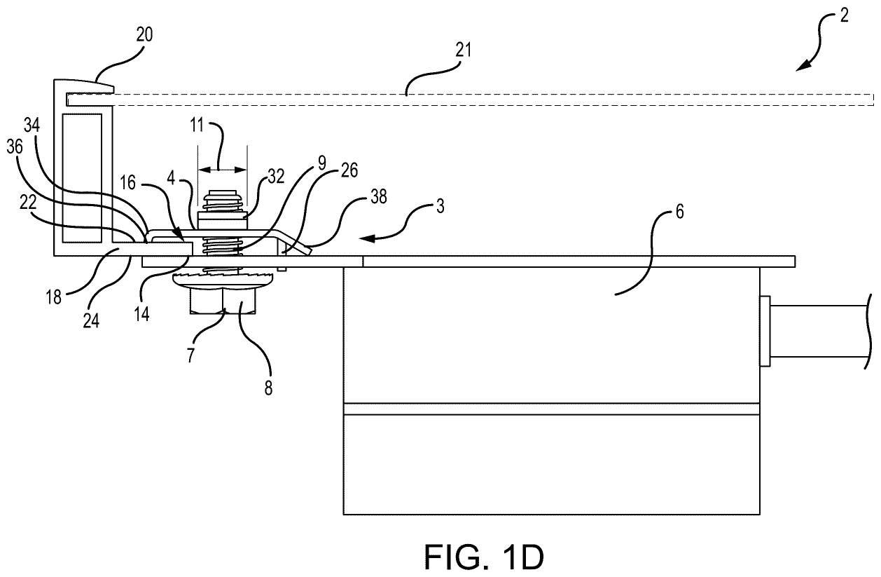

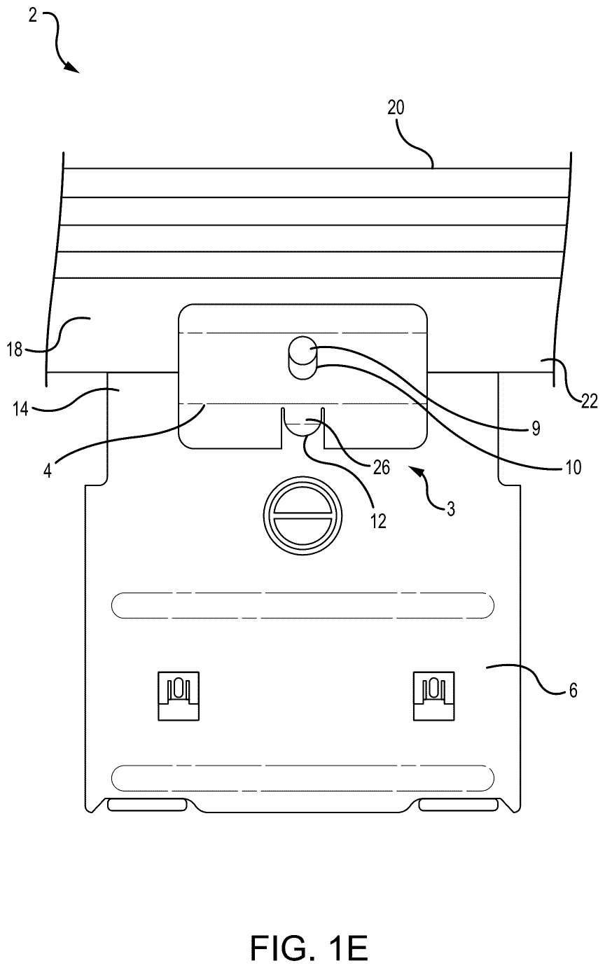

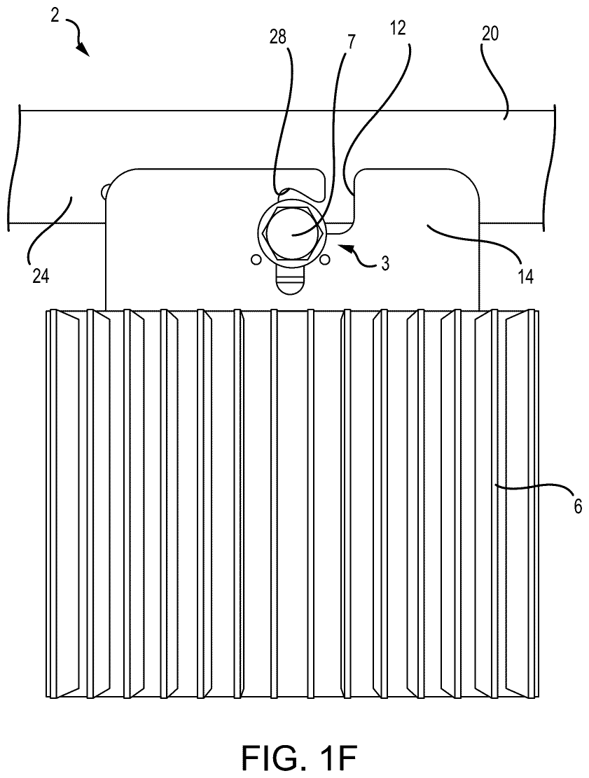

FIGS. 1A-IF generally illustrate a first embodiment of a photovoltaic (PV) system 2 and a mounting system 3, according to embodiments of the present disclosure. The PV system 2 includes a mounting device 4 (or mounting bracket 4, or bracket 4, which should all be considered equivalent for purposes of the present disclosure). The mounting device 4 is securable to a module-level power electronics (MLPE) 6, via a fastener 8. A shaft 9 of the fastener 8 passes through an aperture 10 (optionally, within a neck 32) of the mounting device 4 and a cutout or slot 12 in an extension 14 of the MLPE 6. It is noted herein the mounting device 4 and the fastener 8 may be considered components of the mounting system 3, for purposes of the present disclosure. Further, although the mounting device 4 is generally illustrated in conjunction with an MLPE, one of skill in the art will appreciate that the mounting device 4 of the present disclosure may be used to interconnect other components or equipment and accessories to the frame 20 of the PV system 2.

In some embodiments, the fastener 8 is inserted through the extension 14 prior to engaging the mounting device 4. The fastener 8 may include a head 7, and a shaft 9 with a diameter 11. For example, the diameter 11 is optionally from 6 mm to 10 mm, or 8 mm (commonly referred to as “M8” diameter). It is noted the head 7 may include a diameter that is greater than, less than, or equal to the shaft diameter 11.

In one non-limiting example, at least a portion (or optionally all) of the shaft 9 has an exterior thread. More specifically, in some non-limiting examples, the exterior thread extends from the head 7 to a free end of the shaft 9. Alternatively, in other non-limiting examples, only a portion of the shaft 9 is threaded. Accordingly, in at least one embodiment, the exterior thread extends from the free end of the shaft 9 about ¼, ⅓, ½, ⅔, or ¾ of the length of the shaft 9 to the head 7. Thus, at least a portion of the shaft 9 proximate to the head 7 may be unthreaded.

The fastener 8 may be inserted from the bottom of the PV system 2 upwards (or downwards, if portions of the PV system 2 including the MLPE 6 are flipped prior to the fastener 8 being inserted through the extension 14 to engage the mounting device 4). In embodiments, the aperture 10 of the mounting device 4 may include threading or other interlocking components operable to engage the fastener 8 following insertion, to allow for increased case of insertion of the fastener 8 from the bottom of the PV system 2. In one non-limiting example, at least a portion (or optionally all) of the aperture 10 has an interior thread, including where the aperture 10 is in the optional neck 32. More specifically, in some non-limiting examples, the interior thread extends through the mounting device 4. Alternatively, in other non-limiting examples, only a portion of the aperture 10 is threaded. Accordingly, in at least one embodiment, the interior thread extends through about ¼, ⅓, ½, ⅔, or ¾ of the thickness of the mounting device 4. Thus, at least a portion of the aperture 10 may be unthreaded.

The aperture 10 extends along an aperture axis. In at least some embodiments, the aperture axis is oriented at an axis angle of between about 80° and about 100° to an upper surface of the body 30. In at least one embodiment, the aperture axis is oriented at an axis angle of approximately 90° to the upper surface of the body.

Referring to FIGS. 1C and 1D, the PV frame 20 is engaged to a solar panel 21 of the PV system 2. The mounting device 4 facilitates mounting the MLPE 6 to the PV frame 20 below the solar panel 21, so as not to interfere with the positioning of the solar panel 21 within the PV system 2. The solar panel 21 has been removed from FIGS. 1A-1B and 1E-1F for purposes of clarity only, the absence of which is not intended on being limiting on the present disclosure. It is noted that FIG. 1D illustrates a variation of FIG. 1C, in which the optional neck 32 is a different height. For example, the neck 32 in FIG. 1D has a greater or increased height as compared to the neck 32 in FIG. 1C.

A gap 16 is defined between the mounting device 4 and the extension 14 when the mounting device 4 is coupled to the extension 14 via the fastener 8. A frame section 18 of the PV frame 20 is insertable into the gap 16. When the fastener 8 is tightened, the mounting device 4 and the extension 14 are drawn together, securing the mounting device 4 against a first PV frame surface 22 of the frame section 18 and/or securing the extension 14 against a second PV frame surface 24 of the frame section 18. The second PV frame surface 24 is opposite to (or opposes) the first PV frame surface 22.

It is noted that the mounting device 4 operates similar in principle to a lever when the frame section 18 is within the gap 16 and the fastener 8 is tightened. In particular, a first arm 34 (with an optional plurality of teeth 36) of the mounting device 4 presses down on the first PV frame surface 22 and the weight of the MLPE 6 pushes up on the second PV frame surface 24. In addition, it is noted that the mounting device 4 provides a grounding path between the frame section 18 of the PV frame 20 and the extension 14 of the MLPE 6. For example, the first arm 34 (with the optional plurality of teeth 36) may cut into (or otherwise engage) the first PV frame surface 22 when the fastener 8 is tightened to draw together the mounting device 4 and the extension 14.

In embodiments, the mounting device 4 optionally includes a tab 26. As illustrated in FIG. 1B, the tab 26 and the fastener 8 are dimensioned and shaped to fit into the cutout 12. In addition, as illustrated in FIGS. 1A and 1E, the tab 26 is inserted into the cutout 12 of the extension 14 when the mounting device 4 and the MLPE 6 are secured together. It is noted that the tab 26 may operate like an additional arm or other securing mechanism by engaging the cutout 12 and preventing twisting or shifting of the mounting device 4. In this manner, the tab 26 makes installation easier by preventing inadvertent or unintended twisting or rotation of the mounting device 4 relative to the frame 20 and/or to the MLPE 6 as the fastener 8 is rotated.

As illustrated in FIG. 1F, the fastener 8 is inserted within (or through) the cutout 12, with the cutout 12, and the head 7 being dimensioned to prevent the head 7 from passing through the cutout 12. Optionally, the cutout 12 is shaped to include one or more bends or curves 28 to assist in keeping the fastener 8 retained within the cutout 12 (e.g., where the fastener 8 has loosened). It is noted, however, that the cutout 12 may be straight or substantially straight and without bends, without departing from the scope of the present disclosure.

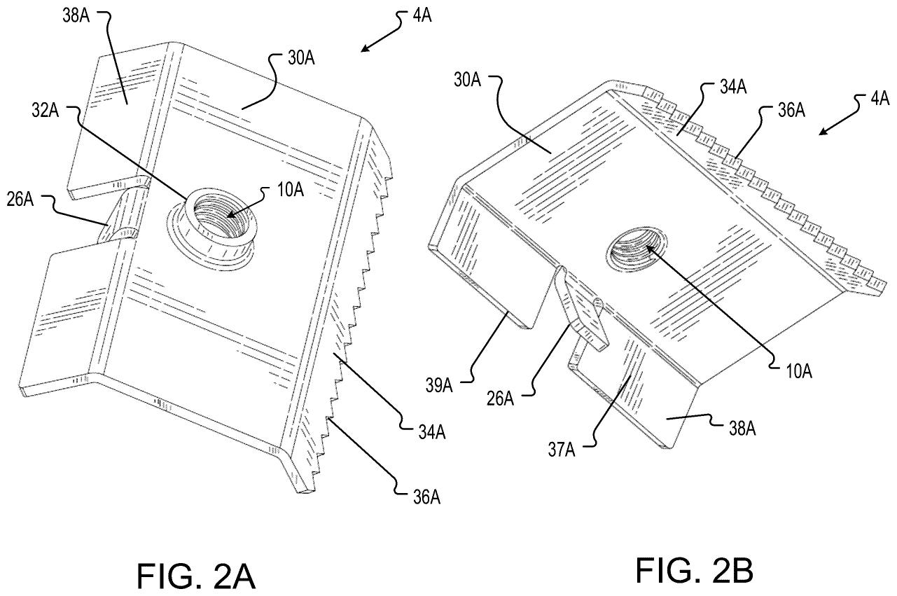

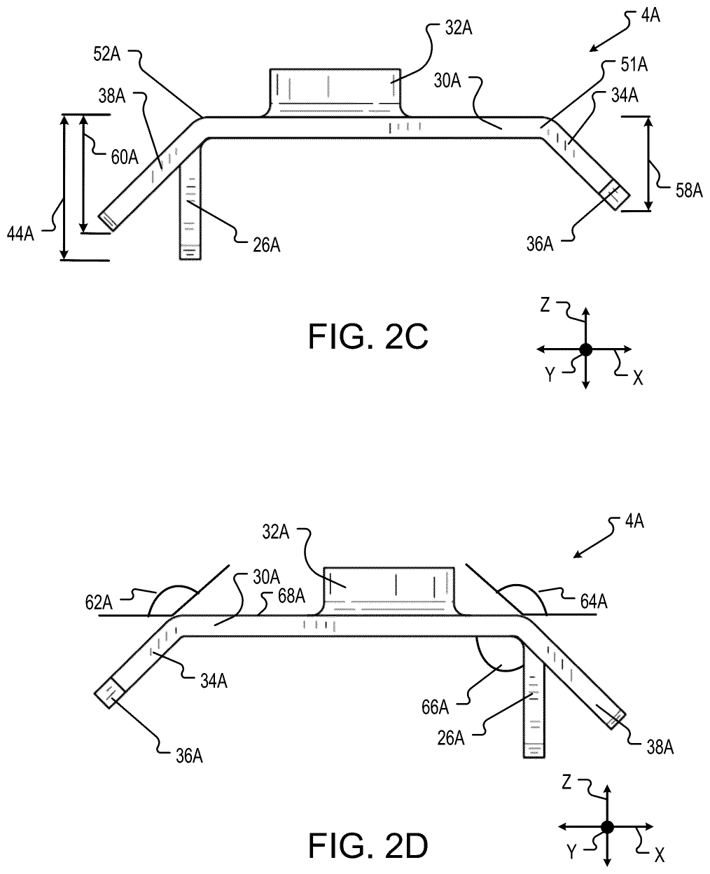

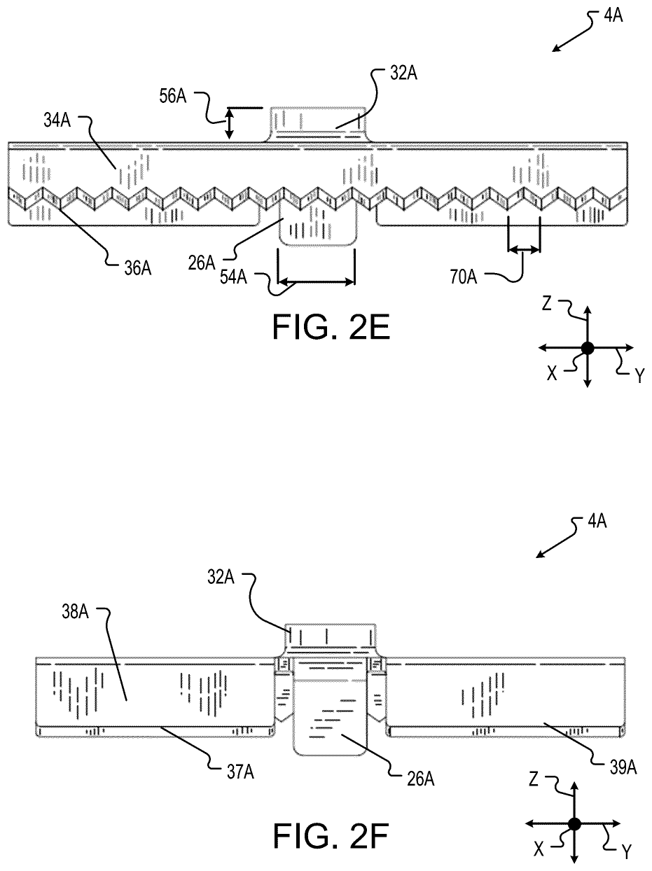

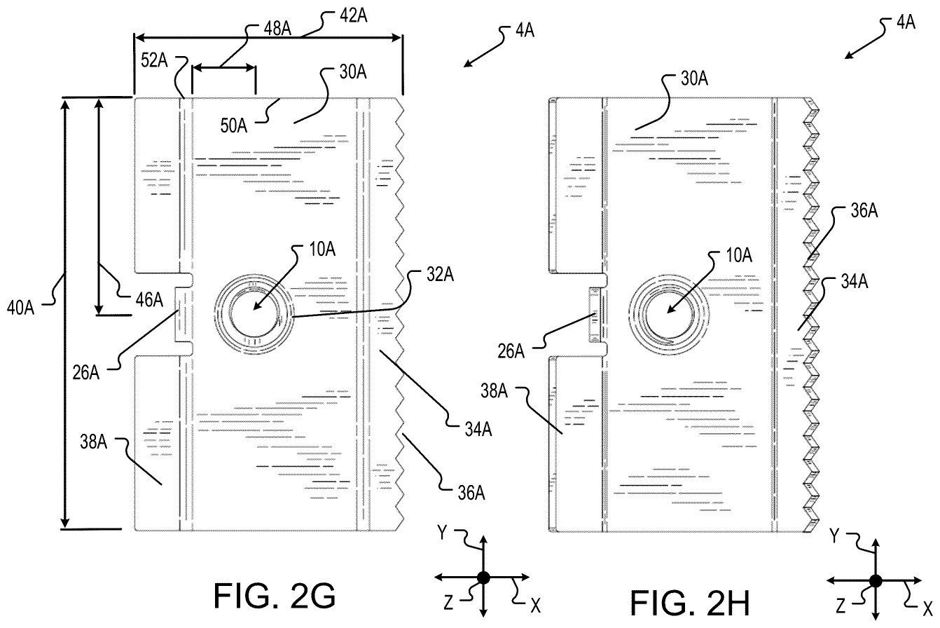

FIGS. 2A-2H, 3A-3H, 4A-4I, 5, 6, 7A-7H, and 8A-8I illustrate mounting devices 4A, 4B, 4C, 4D, 4E, 4F, 4G respectively. It should be understood that any of the mounting devices 4A-4G may be used in the PV system 2 of FIGS. 1A-1F in place of the mounting device 4. Unless otherwise noted, it should also be understood that embodiments and/or aspects as referred to in FIGS. 1A-1F, 2A-2H, 3A-3H, 4A-4I, 5, 6, 7A-7H, and 8A-8I are interchangeable and/or combinable. It is noted herein that FIGS. 2A-8I illustrate exemplary coordinate axes that represent a lateral dimension or direction X, a longitudinal dimension or direction Y, and a vertical or height dimension or direction Z, but that the coordinate axes are not intended to be limiting on the present disclosure.

FIGS. 2A-2H illustrate the mounting device 4A, according to embodiments of the present disclosure. In at least some aspects, the mounting device 4A is similar to the mounting device 4 illustrated in FIG. 1D.

The mounting device 4A includes a body 30A. The body 30A includes a neck 32A, and the aperture 10A is in the body 30A and the neck 32A. In embodiments, at least a portion of the neck 32A and/or the aperture 10A is threaded to receive the fastener 8 (e.g., as illustrated in FIGS. 1A-1F). In one non-limiting example, at least a portion (or optionally all) of the neck 32A has an interior thread. More specifically, in some non-limiting examples, the interior thread extends the height of the neck 32A. Alternatively, in other non-limiting examples, only a portion of the neck 32A is threaded. Accordingly, in at least one embodiment, the interior thread extends through about ¼, ⅓, ½, ⅔, or ¾ of the height of the neck 32A. Thus, at least a portion of the neck 32A may be unthreaded. It is noted that the threading may be formed after the neck 32A and/or the aperture 10A are formed, or may be formed concurrently with the forming of the neck 32A and/or the aperture 10A.

The mounting device 4A includes a first arm 34A extending from a first side of the body 30A. In some embodiments, a distal end of the first arm 34A includes a plurality of teeth 36A, or other engaging features, that are operable to make contact with the frame section 18 (e.g., as illustrated in FIG. 1E). It is noted that the plurality of teeth 36A, or other engaging features, may indent or cut (or “bite”) into the frame section 18 to increase a holding force applied by the mounting device 4A on the PV frame 20 (e.g., as illustrated in FIG. 1E). Further, the teeth 36A may improve the electrical bonding (and the grounding path) between the frame section 18 of the PV frame 20 and the extension 14 of the MLPE 6.

The mounting device 4A includes a tab 26A extending from the body 30A. The mounting device 4A includes a second arm 38A extending from a second side of the body 30A. In some embodiments, the tab 26A is formed from a section of the second arm 38A opposite the teeth 36A in the first arm 34A via one or more simultaneous, substantially simultaneous, or subsequent fabrication processes, such that the tab 26A extends from the second side of the body 30A. In these embodiments, the positioning of the tab 26A may separate the second arm 38A into portions 37A, 39A. Alternatively, the tab 26A may be coupled or affixed to the mounting device 4A proximate to the second arm 38A (and opposite the teeth 36A), such that the tab 26A may or may not separate the second arm 38A into portions 37A, 39A. In some embodiments, the tab 26A is aligned with the aperture 10A (e.g., where the tab 26A and the fastener 8 are both inserted into (or extend through) the same cutout 12 of the extension 14 of the MLPE 6).

In embodiments, the combination of the plurality of teeth 36A (e.g., on the first arm 34A) and the tab 26A prevents the rotation of the MLPE 6 relative to the PV frame 20 via the engagement of the mounting device 4A with the MLPE 6 and the PV frame 20, respectively (e.g., as illustrated in FIGS. 1C-1D). For example, the preventing of rotation is beneficial when the fastener 8 engages the threaded aperture 10A, during securing of the MLPE 6 to the PV frame 20 via engagement of the mounting device 4A to both the MLPE 6 and the PV frame 20.

The mounting device 4A includes a total length 40A, a total width 42A, and a tab height 44A. A center of the aperture 10A is positioned at an aperture length 46A and an aperture width 48A. The aperture length 46A may be measured from an outer edge 50A, while the aperture width 48A may be measured from a corner or bend 52A separating the body 30A from the second arm 38A. It is noted that the body 30A includes a second corner or bend 51A that separates the body 30A from the first arm 34A. The tab 26A includes a tab length 54A.

The neck 32A includes a neck height 56A. Optionally, the neck height 56A is sufficient for the neck 32A to receive at least 2.8 revolutions of the interior thread. In some non-limiting instances, the neck height 56A is sufficient to include at least four revolutions of the interior thread. As will be appreciated by one of skill in the art, increasing the number of thread revolutions improves the amount of pull-out force the fastener 8 can withstand before losing thread engagement with the mounting device 4A.

It is noted that an extruded mounting device would require more material to make a body of increased thickness that is at least the neck height 56A, as compared to the neck 32A being a port formed via a series of fabrication operations (e.g., a series of progressive die processes, including stamping processes, punching processes, and bending processes, or the like), as described in detail further herein. In this regard, the mounting device 4A is not reliant on material thickness to ensure a sufficient amount of threading or thread revolutions within the neck 32A, as compared to an extruded mounting device with increased body thickness, such that the amount of material necessary to fabricate the mounting device 4A is reduced as compared to traditional mounting devices used in other metal panel (e.g., such as those used to form a roof) mounting applications.

The mounting device 4A has a first arm height 58A that is the height of the first arm 34A, and a second arm height 60A that is the height of the second arm 38A. In embodiments, the first arm height 58A is shorter than the second arm height 60A, where the difference in height is at least a thickness of the frame section 18 of the PV frame 20. The difference in the heights 58A, 60A beneficially accommodates differences in thicknesses of frame sections 18 produced by various manufacturers of PV frames 20. In one non-limiting example, the first arm 34A may come into contact with the first PV frame surface 22 of the frame section 18 and the second arm 38A may come into contact with an upper (or first) surface of the extension 14 of the MLPE device 6, due to the difference in arm heights 58A, 60A, when the fastener 8 is fully tightened within the mounting device 4A.

The first arm 34A is set at a first arm angle 62A relative to the body 30A. The second arm 38A is set at a second arm angle 64A relative to the body 30A. The tab 26 is set at a tab angle 66A relative to the body 30A. In general, the angles 62A, 64A, 66A may range from 0 degrees (°) to 180°. In some embodiments, the first arm height 58A and the second arm height 60A are less than the tab height 44A due to the angle of the arms 34A/38A versus the angle 66A of the tab 26A relative to the body 30A.

In one non-limiting example, the mounting device 4A is fabricated from a material having a thickness of about 0.059 inches (1.5 millimeters (mm)). The total length 40A is about 2.48 inches (63 mm), the total width 42A is about 1.548 inches (32 mm), and the tab height 44A is about 0.354 inches (9.0 mm). The aperture length 46A is about 1.234 inches (31.34 mm), and the aperture width 48A is about 0.356 inches (9.04 mm). The tab length 54A is about 0.307 inches (7.8 mm). The neck height 56A is about 0.138 inches (3.5 mm). The first arm height 58A is about 0.213 inches (5.4 mm), and the second arm height 60A is about 0.275 inches (6.99 mm).

The first arm angle 62A is approximately 135° from the body 30A (or approximately 45° below a horizontal plane defined by a body surface 68A of the body 30A). The second arm angle 64A is approximately 135° from the body 30A (or approximately 45° below the defined horizontal plane). The tab angle 66A is approximately 90° from the body 30A (or from the defined horizontal plane). The plurality of teeth 36A have a trough length 70A of about 0.138 inches (3.5 mm). The threading in the aperture 10A and the neck 32A is optionally M8×1.25 threading.

In some embodiments, the processes by which the mounting device 4A is formed using a progressive die includes the forming of the first arm 34A at approximately 135° to the body 30A (or approximately 45° below the horizontal plane defined by the body surface 68A). In addition, the processes by which the mounting device 4A is formed using a progressive die includes the forming of the second arm 38A and the tab 26A at approximately 135° relative to the body 30A (or approximately 45° below the horizontal plane defined by the body surface 68A). The processes by which the mounting device 4A is formed additionally includes a second process to further bend the tab 26A to about 90° below the body 30A (or the horizontal plane defined by the body surface 68A).

In some embodiments, the mounting device 4A is formed from a sheet of metal that has a substantially uniform thickness. Accordingly, in at least one embodiment, the body 30A, the first arm 34A, the second arm 38A, and the tab 26B have thicknesses that are substantially equal.

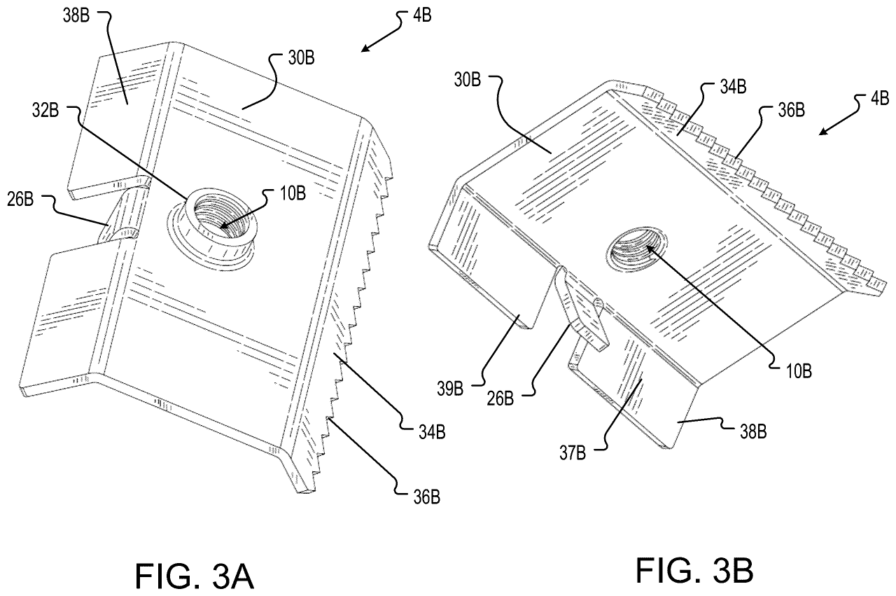

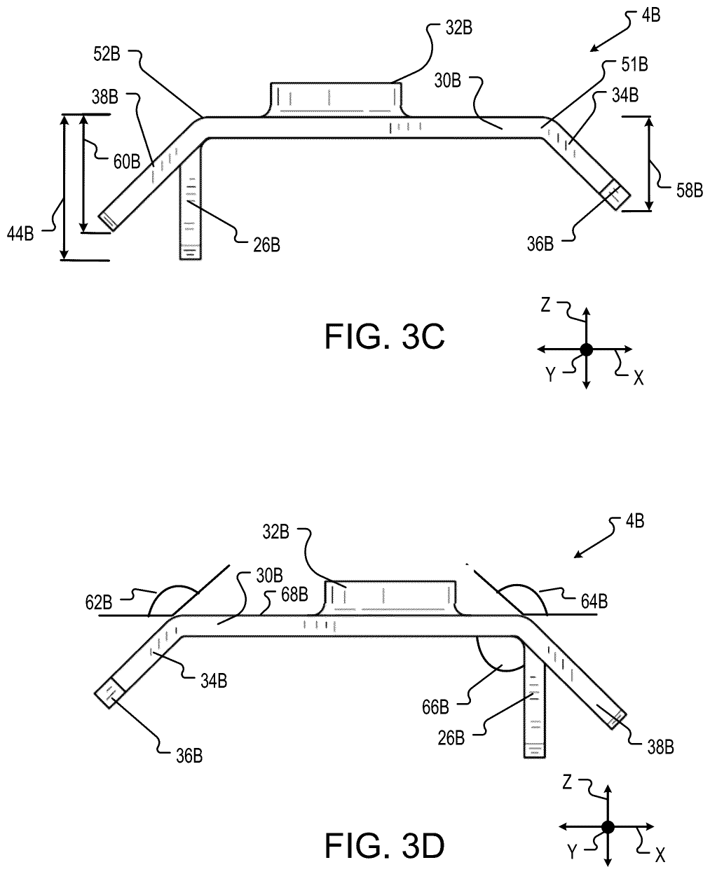

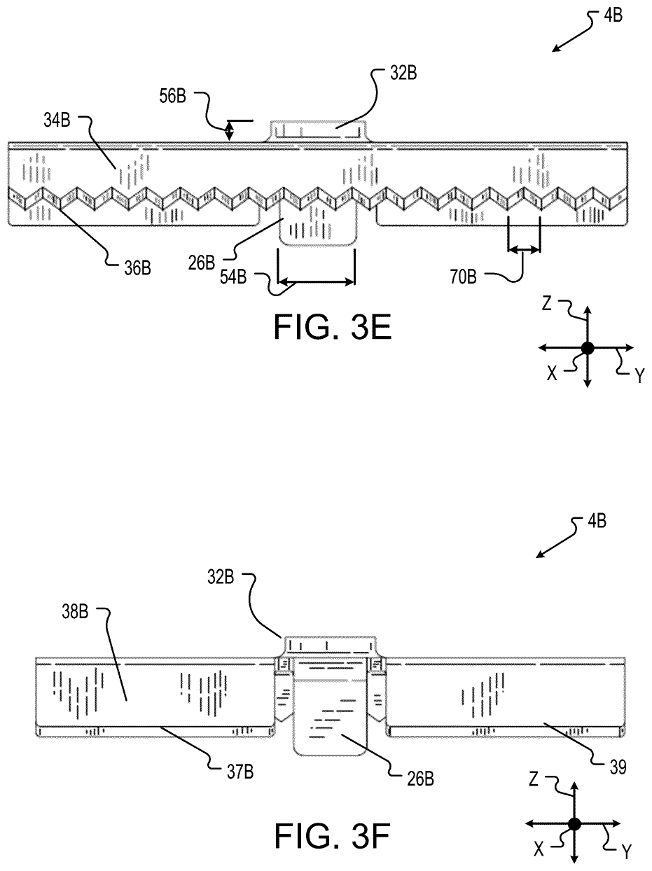

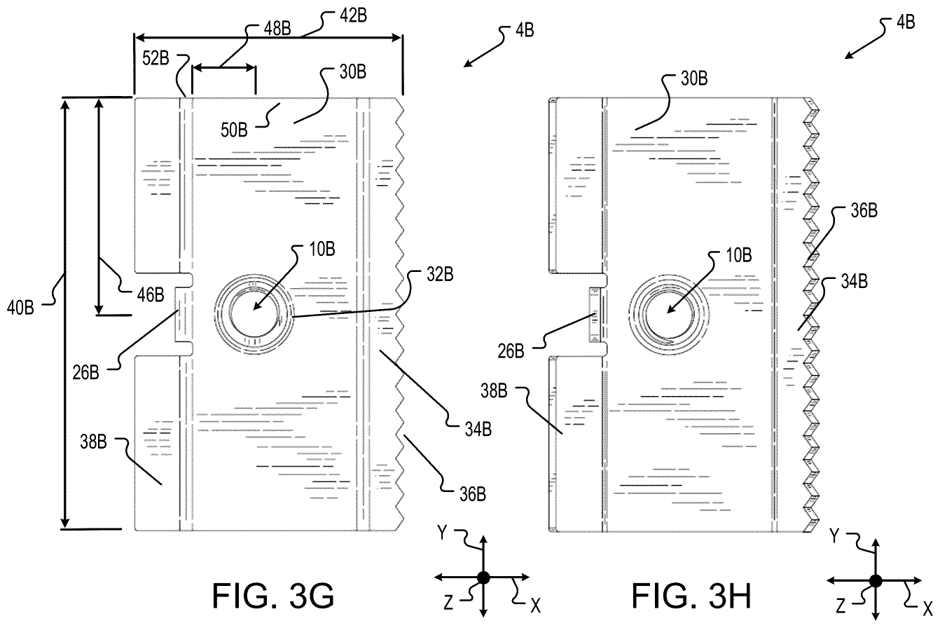

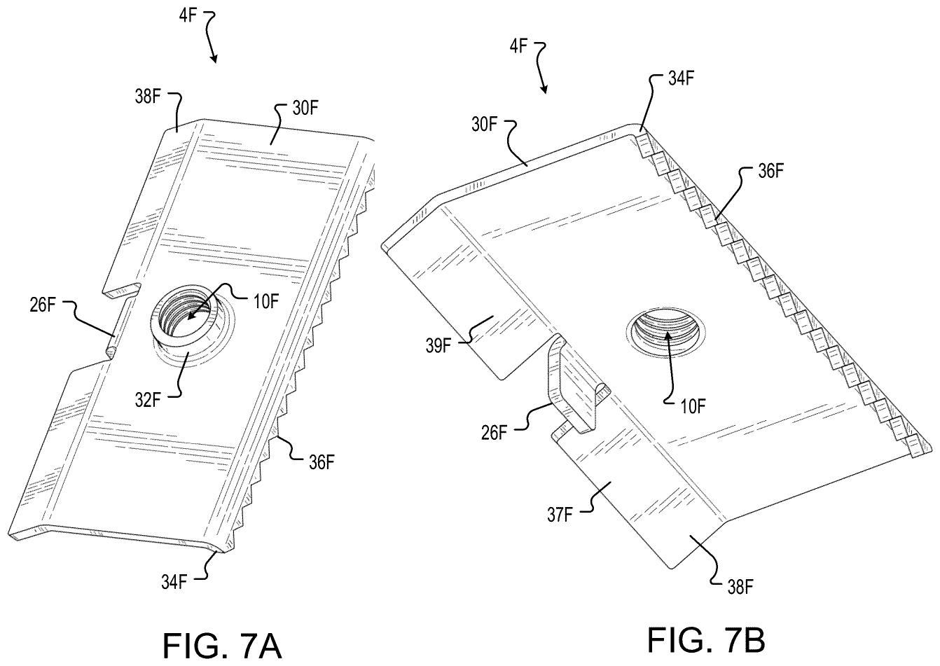

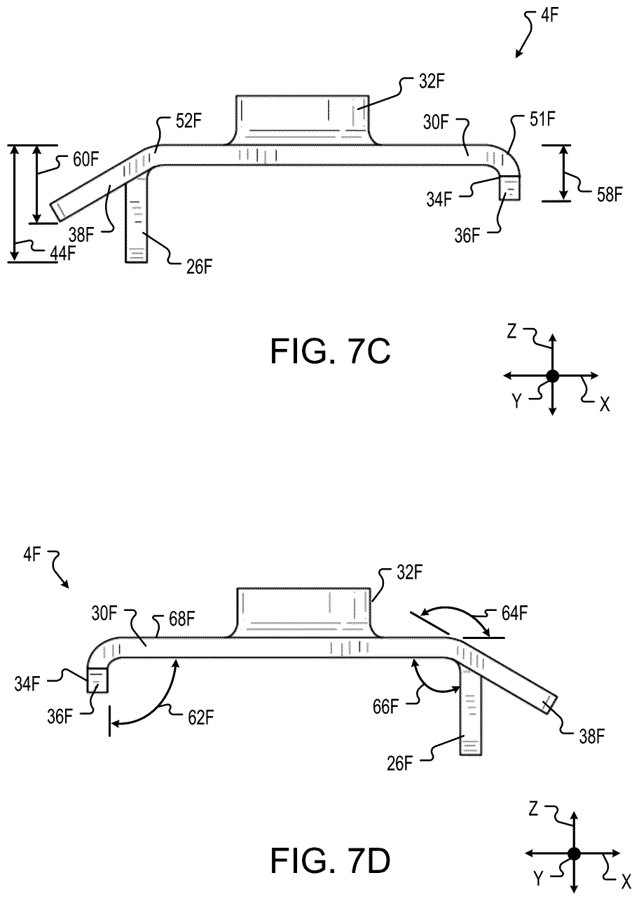

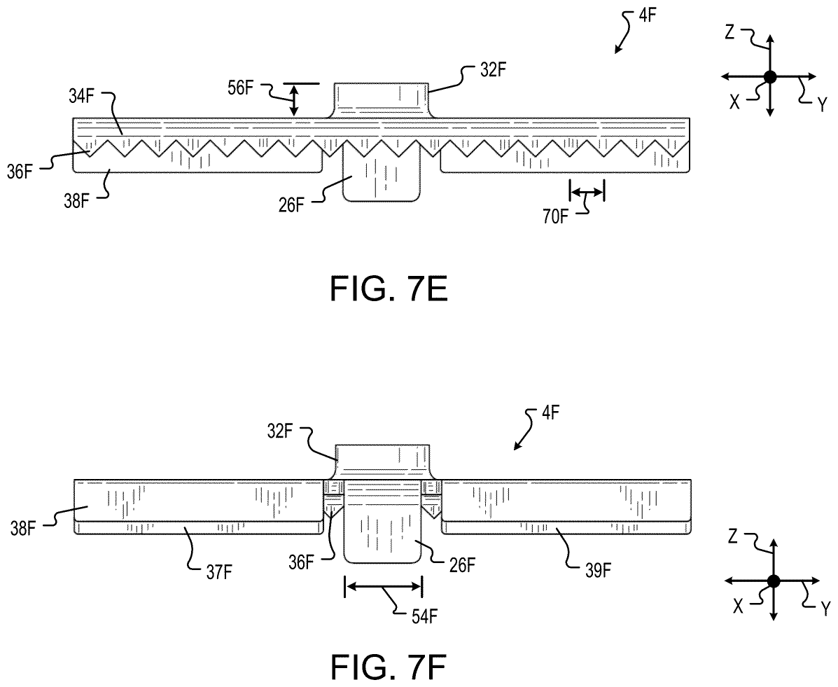

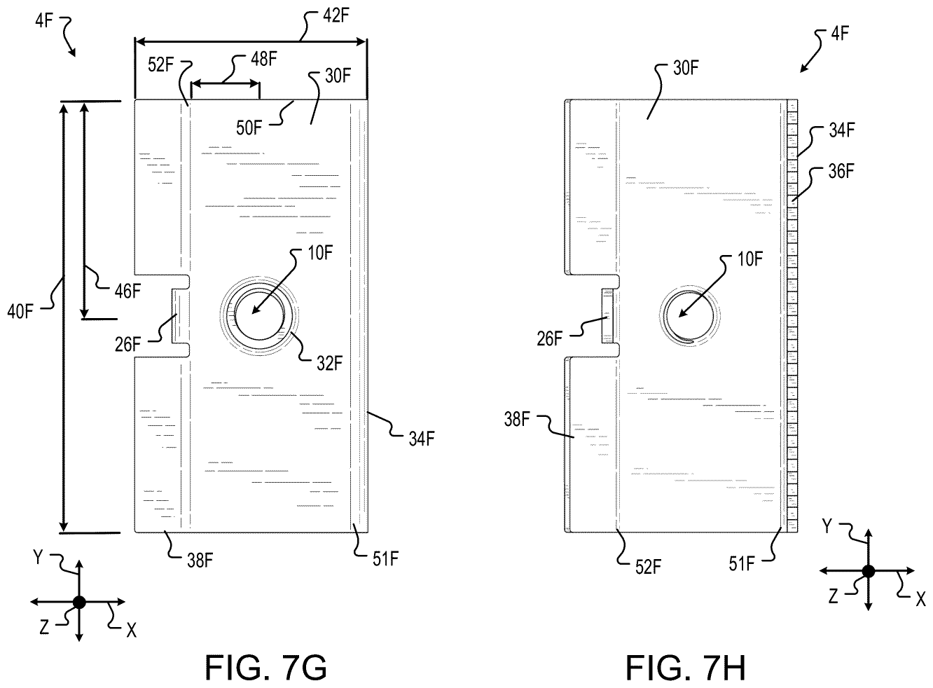

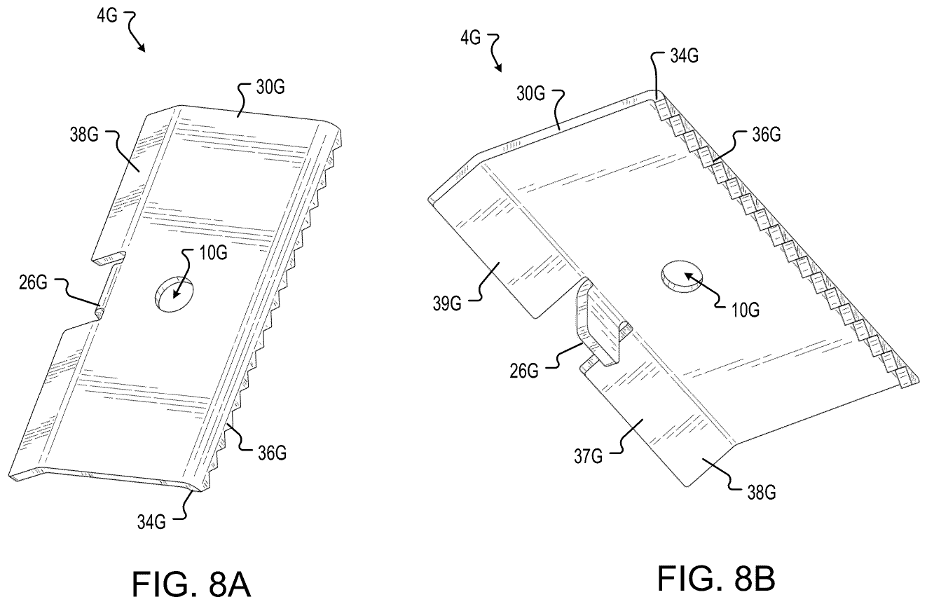

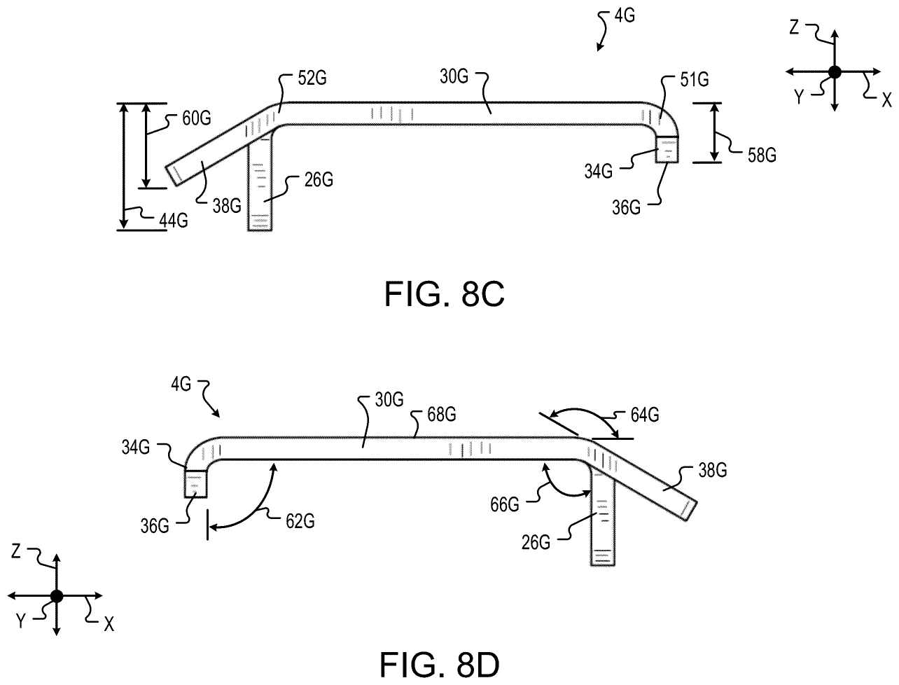

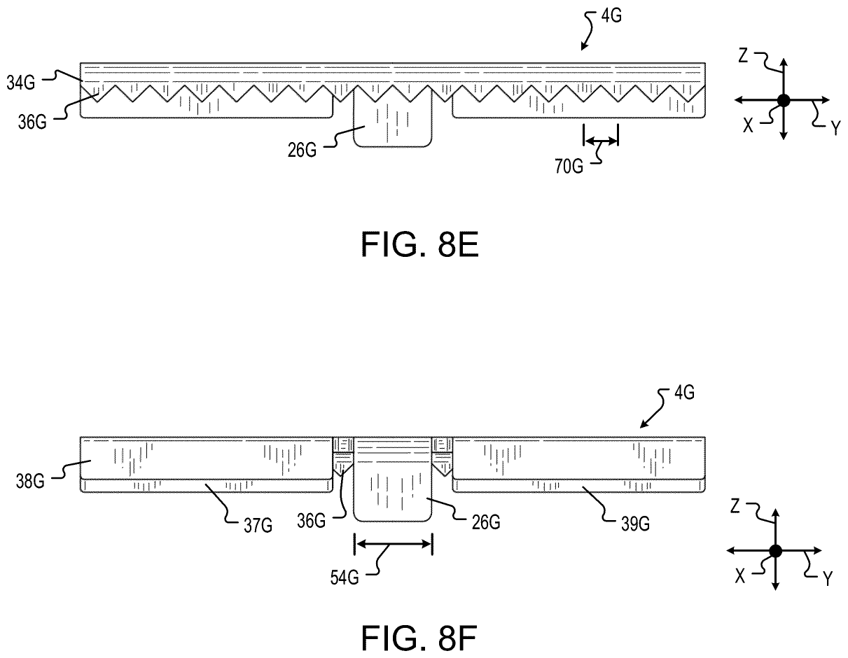

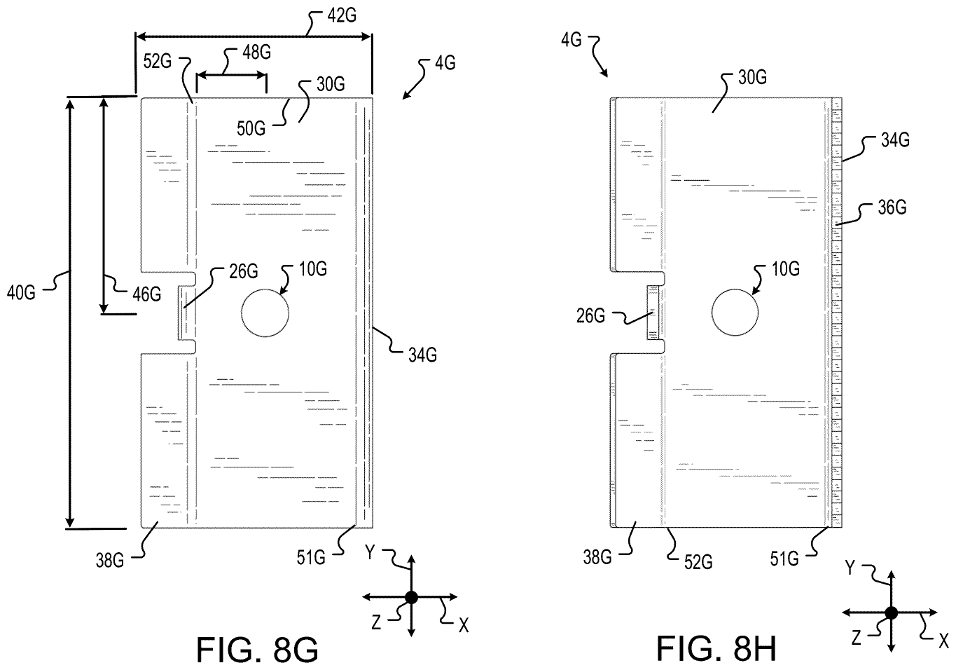

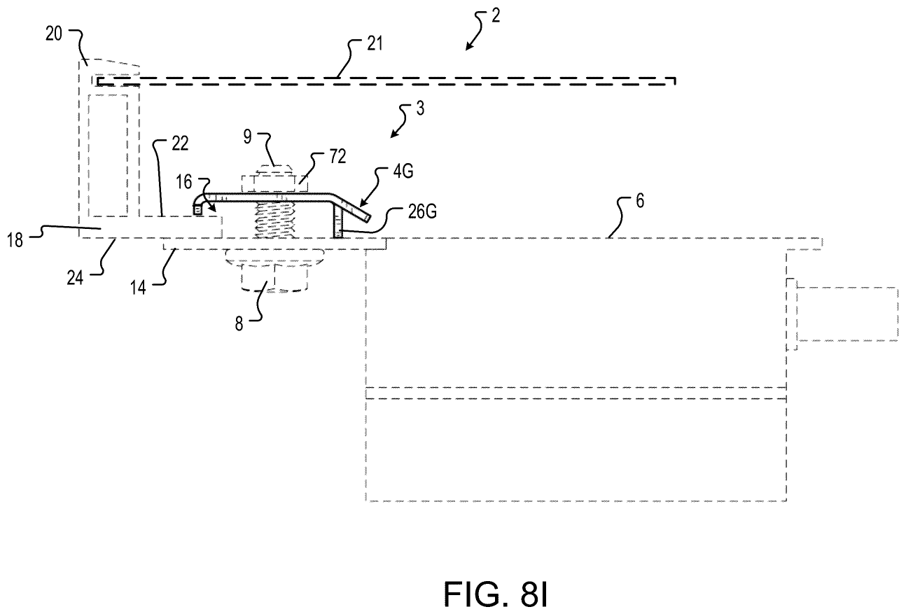

FIGS. 3A-31 illustrate the mounting device 4B, according to embodiments of the present disclosure. The features and function of the mounting device 4B are similar to those of the mounting devices 4, 4A, 4C, 4D, 4E, 4F, 4G. However, the mounting device 4B differs from the mounting devices 4, 4A, 4C, 4D, 4E, 4F, 4G in that the mounting device has a neck 32B which has a different neck height 56B. For example, the neck 32B has a shorter neck height 56B as compared to the neck 32A with neck height 56A illustrated in FIGS. 2A-2H, a neck 32F with neck height 56F illustrated in FIGS. 7A-7H, and a neck 32G with neck height 56G illustrated in FIGS. 8A-8I. The shorter neck 32B is in part due to the fabricating of the mounting device 4B from a thicker metal than the mounting device 4A. In at least some aspects, the mounting device 4B is similar to the mounting device 4 illustrated in FIGS. 1A-IC, 1E, and 1F.

The mounting device 4B includes a body 30B. The mounting device 4B includes an aperture 10B in the body 30B and the neck 32B. In embodiments, at least a portion of the neck 32B and/or the aperture 10B is threaded to receive the fastener 8. In one non-limiting example, at least a portion (or optionally all) of the neck 32B has an interior thread. More specifically, in some non-limiting examples, the interior thread extends the height of the neck 32B. Alternatively, in other non-limiting examples, only a portion of the neck 32B is threaded. Accordingly, in at least one embodiment, the interior thread extends through about ¼, ⅓, ½, ⅔, or ¾ of the height of the neck 32B. Thus, at least a portion of the neck 32B may be unthreaded. It is noted that the threading may be formed after the neck 32B and/or the aperture 10B is formed, or may be formed concurrently with the forming of the neck 32B and/or the aperture 10B.

The mounting device 4B includes a first arm 34B extending from a first side of the body 30B. A distal end of the first arm 34B includes a plurality of teeth 36B, or other engaging features, that are operable to make contact with the frame section 18 (e.g., as illustrated in FIG. 1E). It is noted that the plurality of teeth 36B may indent or cut (or “bite”) into the frame section 18 to increase a holding force applied by the mounting device 4B on the PV frame 20 (e.g., as illustrated in FIG. 1E). Further, the teeth 36B may improve the electrical bonding (and the grounding path) between the frame section 18 of the PV frame 20 and the extension 14 of the MLPE 6.

The mounting device 4B includes a tab 26B extending from the body 30B. The mounting device 4B includes a second arm 38B extending from a second side of the body 30B. In some embodiments, the tab 26B is formed from a section of the second arm 38B opposite the teeth 36B in the first arm 34B via one or more simultaneous or subsequent fabrication processes, such that the tab 26B extends from the second side of the body 30B. In these embodiments, the positioning of the tab 26B may separate the second arm 38B into portions 37B, 39B. Alternatively, the tab 26B may be affixed to the mounting device 4B (e.g., proximate to the second arm 38B), such that the tab 26B may or may not separate the second arm 38B into portions 37B, 39B. In some embodiments, the tab 26B is aligned with the aperture 10B (e.g., where the tab 26B and the fastener 8 are both inserted into (or extend through) the same cutout 12 of the extension 14 of the MLPE 6).

In embodiments, the combination of the plurality of teeth 36B (e.g., on the first arm 34B) and the tab 26B prevents the rotation of the MLPE 6 relative to the PV frame 20 via the engagement of the mounting device 4B with the MLPE 6 and the PV frame 20, respectively (e.g., as illustrated in FIGS. 1C-1D). For example, preventing rotation is beneficial when the fastener 8 engages the threaded aperture 10B, during securing of the MLPE 6 to the PV frame 20 via engagement of the mounting device 4B to both the MLPE 6 and the PV frame 20.

The mounting device 4B includes a total length 40B, a total width 42B, and a tab height 44B. A center of the aperture 10B is positioned at an aperture length 46B and an aperture width 48B. The aperture length 46B may be measured from an outer edge 50B, while the aperture width 48B may be measured from a corner or bend 52B separating the body 30B from the second arm 38B. It is noted that the body 30B includes a second corner or bend 51B that separates the body 30B from the first arm 34B. The tab 26B includes a tab length 54B.

The neck 32B includes a neck height 56B. Optionally, the neck height 56B is sufficient for the neck 32B to receive at least 2.8 revolutions of the interior thread. It is noted that an extruded mounting device would require more material to make a body of increased thickness that is at least the neck height 56B, as compared to the neck 32B being a port formed via a series of fabrication operations (e.g., a series of progressive die processes, including stamping processes, punching processes, and bending processes, or the like), as described in detail further herein. In this regard, the mounting device 4B is not reliant on material thickness to ensure a sufficient amount of threading or thread revolutions within the neck 32B, as compared to an extruded mounting device with increased body thickness, such that the amount of material necessary to fabricate the mounting device 4B is reduced as compared to traditional mounting devices used in other metal panel (e.g., such as those used to form a roof) mounting applications.

The mounting device 4B has a first arm height 58B that is the height of the first arm 34B, and a second arm height 60B that is the height of the second arm 38B. In embodiments, the first arm height 58B is shorter than the second arm height 60B, where the difference in height is at least a thickness of the frame section 18 of the PV frame 20. The difference in the heights 58B, 60B beneficially accommodates differences in thicknesses of frame sections 18 produced by various manufacturers of PV frames 20. In one non-limiting example, the first arm 34B may come into contact with the first PV frame surface 22 of the frame section 18 and the second arm 38B may come into contact with an upper (or first) surface of the extension 14 of the MLPE device 6, due to the difference in arm heights 58B, 60B, when the fastener 8 is fully tightened within the mounting device 4B.

The first arm 34B is set at a first arm angle 62B relative to the body 30B. The second arm 38B is set at a second arm angle 64B relative to the body 30B. The tab 26B is set at a tab angle 66B relative to the body 30B. In general, the angles 62B, 64B, 66B may range from 0° to 180°. In some embodiments, the first arm height 58B and the second arm height 60B are less than the tab height 44B due to the angle of the arms 34B/38B versus the tab 26B relative to the body 30B.

In one non-limiting example, the mounting device 4B is fabricated from a material having a thickness of about 0.063 inches (1.6 millimeters (mm)). The total length 40B is about 2.48 inches (63 mm), the total width 42B is about 1.55 inches (39.36 mm), and the tab height 44B is about 0.35 inches (8.89 mm). The aperture length 46B is about 1.234 inches (31.34 mm), and the aperture width 48B is about 0.356 inches (9.04 mm). The tab length 54B is about 0.307 inches (7.8 mm). The neck height 56B is about 0.062 inches (1.56 mm). The first arm height 58B is about 0.211 inches (5.36 mm), and the second arm height 60B is about 0.274 inches (6.95 mm).

The first arm angle 62B is approximately 135° from the body 30B (or approximately 45° below a horizontal plane defined by a body surface 68B of the body 30B). The second arm angle 64B is approximately 135° from the body 30B (or approximately 45° below the defined horizontal plane). The tab angle 66B is approximately 90° from the body 30B (or from the defined horizontal plane). The plurality of teeth 36B have a trough length 70B of about 0.138 inches (3.5 mm). The threading in the aperture 10B and neck 32B is optionally M8×1.25 threading.

In some embodiments, the processes by which the mounting device 4B is formed using a progressive die includes the forming of the first arm 34B at approximately 135° to the body surface 68B (or approximately 45° below the horizontal plane defined by the body surface 68B). In addition, the processes by which the mounting device 4B is formed using a progressive die includes the forming of the second arm 38B and the tab 26B at approximately 135° relative to the body 30B (or approximately 45° below the horizontal plane defined by the body surface 68B). The processes by which the mounting device 4B is formed additionally includes a second process to further bend the tab 26B to about 90° below the body 30B (or the horizontal plane defined by the body surface 68B).

In some embodiments, the mounting device 4B is formed from a sheet of metal that has a substantially uniform thickness. Accordingly, in at least one embodiment, the body 30B, the first arm 34B, the second arm 38B, and the tab 26B have thicknesses that are substantially equal.

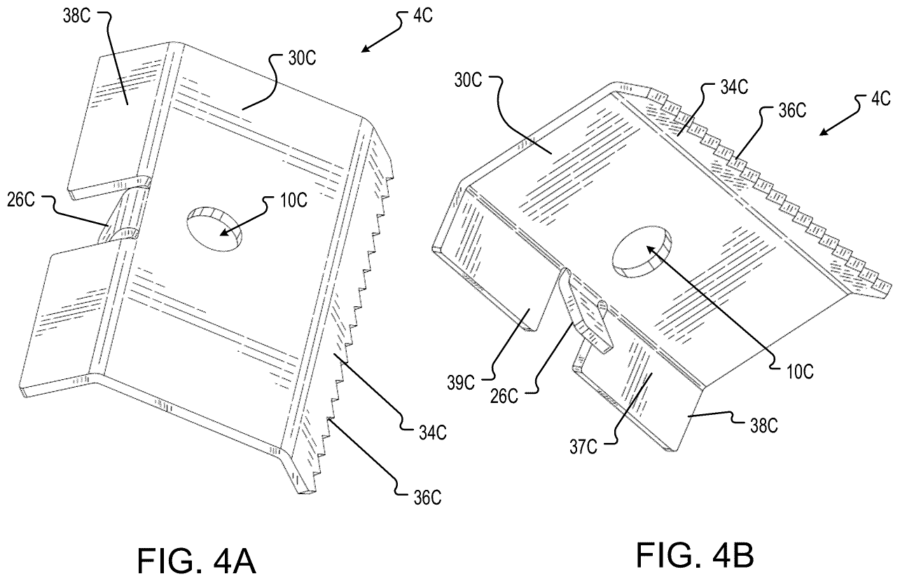

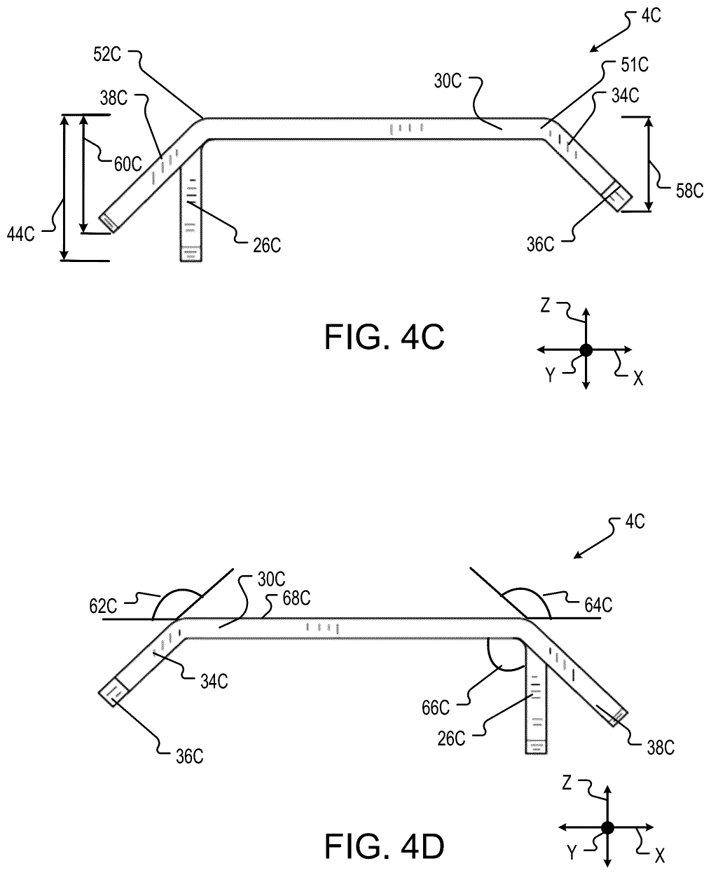

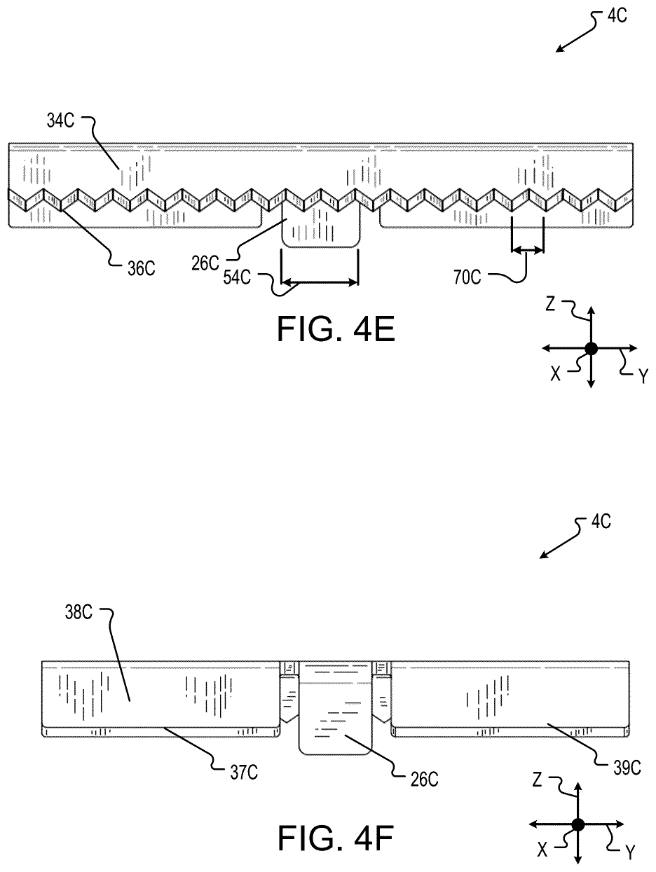

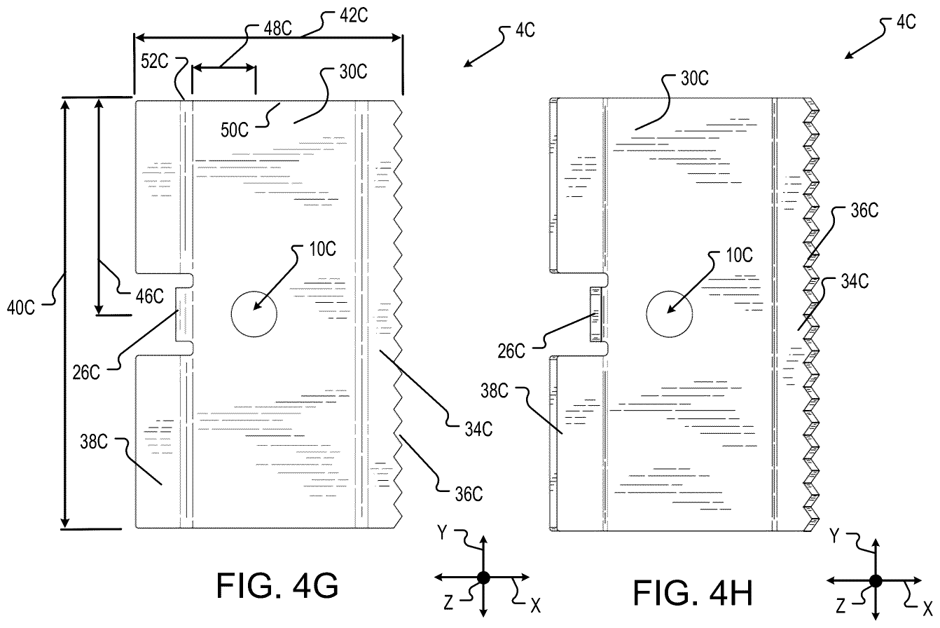

FIGS. 4A-4I illustrate the mounting device 4C, according to embodiments of the present disclosure. The features and function of the mounting device 4C are similar to those of the mounting devices 4, 4A, 4B, 4D, 4E, 4F, 4G. However, the mounting device 4C differs from the mounting devices 4, 4A, 4B, 4D, 4E, 4F, 4G in that there is no neck 32 or threading.

The mounting device 4C includes an aperture 10C and no neck or threading. The mounting device 4B includes a body 30C, and the aperture 10C is in the body 30C.

As illustrated in FIG. 4I, the PV system 2 requires a fastener receiver 72 for the fastener 8 due to the lack of threading in the aperture 10. For example, where the fastener 8 is a bolt, the fastener receiver 72 may be a nut. Optionally, where the fastener 8 is threaded, a length of the fastener 8 that allows for at least 2.8 revolutions of the fastener receiver 72 onto the fastener 8 passes through and exits the mounting device 4C.

It is noted herein the mounting device 4, the fastener 8, and the fastener receiver 72 may be considered components of the mounting system 3, for purposes of the present disclosure. In addition, it is noted herein that the fastener receiver 72 may be usable with the mounting devices 4, 4A, 4B, 4D, 4E, 4F as described throughout the present disclosure, as an additional amount of threading to further secure the fastener 8 within the respective mounting devices 4 (e.g., by causing binding or other interference between the respective neck 32 and the fastener receiver 72 should the fastener 8 attempt to disengage from the respective neck 32). Further, it is noted herein that the solar panel 21 of the PV system 2 has been removed from FIG. 4I for purposes of clarity only, the absence of which is not intended on being limiting on the present disclosure.

The mounting device 4C includes a first arm 34C extending from a first side of the body 30C. A distal end of the first arm 34C includes a plurality of teeth 36C, or other engaging features, that are operable to make contact with the frame section 18 (e.g., as illustrated in FIG. 1E). It is noted that the plurality of teeth 36C may indent or cut (or “bite”) into the frame section 18 to increase the holding forces applied between the mounting device 4C and the PV frame 20 (e.g., as illustrated in FIG. 1E). Further, the teeth 36C may improve the electrical bonding (and the grounding path) between the frame section 18 of the PV frame 20 and the extension 14 of the MLPE 6.

The mounting device 4C includes a tab 26C extending from the body 30C. The mounting device 4C includes a second arm 38C extending from a second side of the body 30C. In some embodiments, the tab 26C is formed from a section of the second arm 38C via one or more simultaneous or subsequent fabrication processes, such that the tab 26C extends from the second side of the body 30C. In these embodiments, the positioning of the tab 26C may separate the second arm 38C into portions 37C, 39C. Alternatively, the tab 26C may be affixed to the mounting device 4C (e.g., proximate to the second arm 38C), such that the tab 26C may or may not separate the second arm 38C into portions 37C, 39C. In some embodiments, the tab 26C is aligned with the aperture 10C (e.g., where the tab 26C and the aperture 10C are inserted into the same cutout 12 of the extension 14 of the MLPE 6).

In embodiments, the combination of the plurality of teeth 36C (e.g., on the first arm 34C) and the tab 26C prevents the rotation of the MLPE 6 relative to the PV frame 20 via the engagement of the mounting device 4C with the MLPE 6 and the PV frame 20, respectively (e.g., as illustrated in FIGS. 1C-1D). For example, preventing rotation is beneficial when the fastener 8 passes through the aperture 10C, during securing of the MLPE 6 to the PV frame 20 via engagement of the mounting device 4C to both the MLPE 6 and the PV frame 20.

The mounting device 4C includes a total length 40C, a total width 42C, and a tab height 44C. A center of the aperture 10C is positioned at an aperture length 46C and an aperture width 48C. The aperture length 46C may be measured from an outer edge 50C, while the aperture width 48C may be measured from a corner 52C separating the body 30C from the second arm 38C. It is noted that the body 30A includes a second corner or bend 51A that separates the body 30A from the first arm 34A. The tab 26C includes a tab length 54C.

The mounting device 4C has a first arm height 58C that is the height of the first arm 34C, and a second arm height 60C that is the height of the second arm 38C. In embodiments, the first arm height 58C is shorter than the second arm height 60C, where the difference in height is at least a thickness of the frame section 18 of the PV frame 20. The difference in the heights 58C, 60C beneficially accommodates differences in thicknesses of frame sections 18 produced by various manufacturers of PV frames 20. In one non-limiting example, the first arm 34C may come into contact with the first PV frame surface 22 of the frame section 18 and the second arm 38C may come into contact with an upper (or first) surface of the extension 14 of the MLPE device 6, due to the difference in arm heights 58C, 60C, when the fastener 8 is fully tightened within the mounting device 4C.

The first arm 34C is set at a first arm angle 62C relative to the body 30C. The second arm 38C is set at a second arm angle 64C relative to the body 30C. The tab 26C is set at a tab angle 66C relative to the body 30C. In general, the angles 62C, 64C, 66C may range from 0° to 180°. In some embodiments, the first arm height 58C and the second arm height 60C are less than the tab height 44C due to the angle of the arms 34C/38C versus the tab 26C relative to the body 30C.

In one non-limiting example, the mounting device 4C is fabricated from a material having a thickness of about 0.059 inches (1.5 millimeters (mm)). The total length 40C is about 2.48 inches (63 mm), the total width 42C is about 1.548 inches (32 mm), and the tab height 44C is about 0.354 inches (9.0 mm). The aperture length 46C is about 1.234 inches (31.34 mm), and the aperture width 48C is about 0.356 inches (9.04 mm). The tab length 54C is about 0.307 inches (7.8 mm). The first arm height 58C is about 0.213 inches (5.4 mm), and the second arm height 60C is about 0.275 inches (6.99 mm).

The first arm angle 62C is approximately 135° from the body 30C (or approximately 45° below a horizontal plane defined by an upper body surface 68C of the body 30C). The second arm angle 64C is approximately 135° from the body 30C (or approximately 45° below the defined horizontal plane). The tab angle 66C is approximately 90° from the body 30A (or from the defined horizontal plane). The plurality of teeth 36C have a trough length 70 of about 0.138 inches (3.5 mm).

In some embodiments, the processes by which the mounting device 4C is formed using a progressive die includes the forming of the first arm 34C at approximately 135° to the body 30C (or approximately 45° below the horizontal plane defined by the body surface 68C). In addition, the processes by which the mounting device 4C is formed using a progressive die includes the forming of the second arm 38C and the tab 26C at approximately 135° relative to the body 30C (or approximately 45° below the horizontal plane defined by the body surface 68C). The processes by which the mounting device 4C is formed additionally includes a second process to further bend the tab 26C to about 90° below the body 30C (or the horizontal plane defined by the body surface 68C).

In some embodiments, the mounting device 4C is formed from a sheet of metal that has a substantially uniform thickness. Accordingly, in at least one embodiment, the body 30C, the first arm 34C, the second arm 38C, and the tab 26C have thicknesses that are substantially equal.

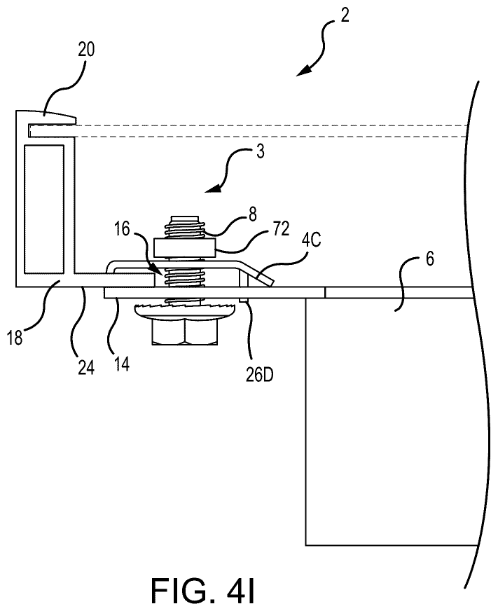

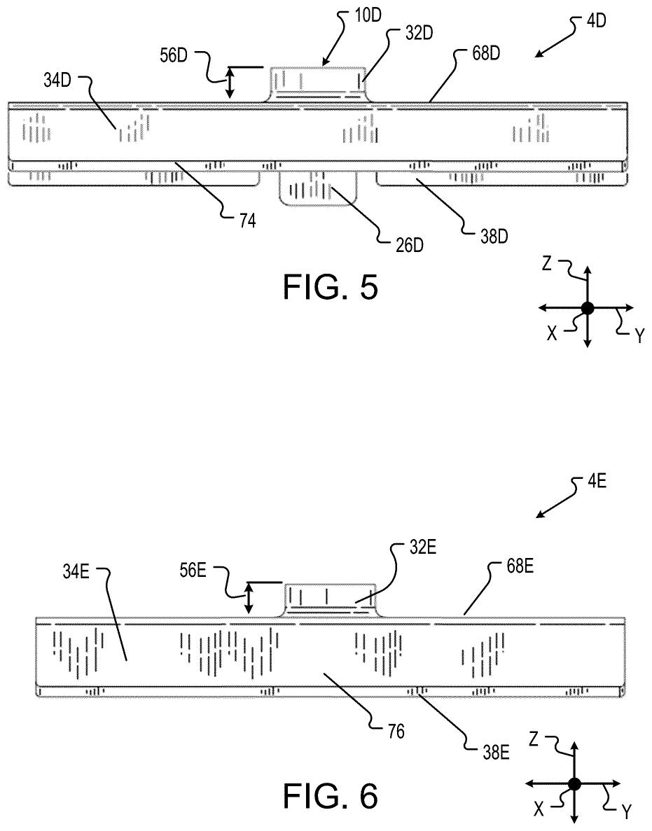

FIG. 5 illustrates the mounting device 4D, according to embodiments of the present disclosure. The features and function of the mounting device 4D are similar to those of the mounting devices 4, 4A, 4B, 4C, 4E, 4F, 4G. However, the mounting device 4D differs from the mounting devices 4, 4A, 4B, 4C, 4E, 4F, 4G in that a first arm 34D does not include teeth. Instead, the mounting device 4D includes the first arm 34D with a smooth or substantially smooth edge or surface 74. In this embodiment, the mounting device 4D does not cut into or indent the first PV frame surface 22 (e.g., as illustrated in FIG. 1F), but only rests on the PV frame surface 22 when the fastener 8 is tightened. It is noted herein that other aspects of the mounting devices 4, 4A, 4B, 4C, 4E, 4F, 4G are combinable with the smooth or substantially smooth edge or surface 74, without departing from the scope of the present disclosure.

In embodiments, a tab 26D assists in preventing the rotation of the MLPE 6 relative to the PV frame 20 via the engagement of the mounting device 4D with the MLPE 6 and the PV frame 20, respectively (e.g., as illustrated in FIGS. 1C-1D). For example, preventing rotation is beneficial when the fastener 8 passes through an aperture 10D within a neck 32D, during securing of the MLPE 6 to the PV frame 20 via engagement of the mounting device 4D to both the MLPE 6 and the PV frame 20.

It is noted that an extruded mounting device would require more material to make a body of increased thickness that is at least a neck height 56D of the neck 32D, as compared to the neck 32D being a port formed via a series of fabrication operations (e.g., a series of progressive die processes, including stamping processes, punching processes, and bending processes, or the like), as described in detail further herein. In this regard, the mounting device 4D is not reliant on material thickness to ensure a sufficient amount of threading or thread revolutions within the neck 32D, as compared to an extruded mounting device with increased body thickness, such that the amount of material necessary to fabricate the mounting device 4D is reduced as compared to traditional mounting devices used in other metal panel (e.g., such as those used to form a roof) mounting applications.

In some embodiments, the processes by which the mounting device 4D is formed using a progressive die includes the forming of the first arm 34D at approximately 135° to the body 30D (or approximately 45° below the horizontal plane defined by the body surface 68D). In addition, the processes by which the mounting device 4D is formed using a progressive die includes the forming of the second arm 38D and the tab 26D at approximately 135° relative to the body 30D (or approximately 45° below the horizontal plane defined by the body surface 68D). The processes by which the mounting device 4D is formed additionally includes a second process to further bend the tab 26D to about 90° below the body 30D (or the horizontal plane defined by the body surface 68D).

In some embodiments, the mounting device 4D is formed from a sheet of metal that has a substantially uniform thickness. Accordingly, in at least one embodiment, the body 30D, the first arm 34D, the second arm 38D, and the tab 26D have thicknesses that are substantially equal.

FIG. 6 illustrates the mounting device 4E, according to embodiments of the present disclosure. The features and function of the mounting device 4E are similar to those of the mounting devices 4, 4A, 4B, 4C, 4D, 4F, 4G. However, the mounting device 4E differs from the mounting devices 4, 4A, 4B, 4C, 4D, 4F, 4G in that a second arm 38E does not include the tab.

Instead, the mounting device 4E includes the second arm 38E with an unbroken or continuous surface 76. In this embodiment, the mounting device 4E does not directly engage with the cutout 12 in the extension 14, as there is no tab. It is noted herein that other aspects of the mounting devices 4, 4A, 4B, 4C, 4D, 4F, 4G are combinable with the unbroken or continuous surface 76, without departing from the scope of the present disclosure.

It is noted that an extruded mounting device would require more material to make a body of increased thickness that is at least a neck height 56E of a neck 32E, as compared to the neck 32E being a port formed via a series of fabrication operations (e.g., a series of progressive die processes, including stamping processes, punching processes, and bending processes, or the like), as described in detail further herein. In this regard, the mounting device 4E is not reliant on material thickness to ensure a sufficient amount of threading or thread revolutions within the neck 32E, as compared to an extruded mounting device with increased body thickness, such that the amount of material necessary to fabricate the mounting device 4E is reduced as compared to traditional mounting devices used in other metal panel (e.g., such as those used to form a roof) mounting applications.

In some embodiments, the processes by which the mounting device 4E is formed using a progressive die includes the forming of the first arm 34E at approximately 135° to the body 30E (or approximately 45° below the horizontal plane defined by the body surface 68E). In addition, the processes by which the mounting device 4E is formed using a progressive die includes the forming of the second arm 38E at approximately 135° relative to the body 30E (or approximately 45° below the horizontal plane defined by the body surface 68E).

In some embodiments, the mounting device 4E is formed from a sheet of metal that has a substantially uniform thickness. Accordingly, in at least one embodiment, the body 30E, the first arm 34E, the second arm 38E, and the tab 26E have thicknesses that are substantially equal.

FIGS. 7A-7H illustrate a mounting device 4F, according to embodiments of the present disclosure. The features and function of the mounting device 4F are similar to those of the mounting devices 4, 4A, 4B, 4C, 4D, 4E, 4G. However, the mounting device 4F differs from the mounting devices 4, 4A, 4B, 4C, 4D, 4E, 4G in that some dimensions of the mounting device 4F are different. Moreover, the first arm angle and the second arm angle are different than for the mounting devices 4, 4A, 4B, 4C, 4D, 4E.

The mounting device 4F includes a body 30F. The body 30F includes a neck 32F, and an aperture 10F is in the body 30F and the neck 32F. In embodiments, at least a portion of the neck 32F and/or the aperture 10F is threaded to receive the fastener 8. In one non-limiting example, at least a portion (or optionally all) of the neck 32F has an interior thread. More specifically, in some non-limiting examples, the interior thread extends the height of the neck 32F. Alternatively, in other non-limiting examples, only a portion of the neck 32F is threaded. Accordingly, in at least one embodiment, the interior thread extends through about ¼, ⅓, ½, ⅔, or ¾ of the height of the neck 32F. Thus, at least a portion of the neck 32F may be unthreaded. It is noted that the threading may be formed after the neck 32F and/or the aperture 10F are formed, or may be formed concurrently with the forming of the neck 32F and/or the aperture 10F.

The aperture 10F extends along an aperture axis. In at least some embodiments, the aperture axis is oriented at an axis angle of between about 80° and about 100° to an upper surface of the body 30F. In at least one embodiment, the aperture axis is oriented at an axis angle of approximately 90° to the upper surface of the body.

The mounting device 4F includes a first arm 34F extending from a first side of the body 30F. In some embodiments, a distal end of the first arm 34F includes a plurality of teeth 36F, or other engaging features, that are operable to make contact with the frame section 18 (e.g., as illustrated in FIG. 1E). However, in some embodiments, the first arm 34F may not include teeth similar to the first arm 34D of mounting device 4D.

When present, the plurality of teeth 36F, or other engaging features, may indent or cut (or “bite”) into the frame section 18 to increase a holding force applied by the mounting device 4F on the PV frame 20 (e.g., as illustrated in FIG. 1E). Further, the teeth 36F may improve the electrical bonding (and the grounding path) between the frame section 18 of the PV frame 20 and the extension 14 of the MLPE 6.

The mounting device 4F includes a tab 26F extending from the body 30F. The mounting device 4F includes a second arm 38F extending from a second side of the body 30F opposite to the first side of the body. In some embodiments, the tab 26F is formed from a section of the second arm 38F opposite the teeth 36F in the first arm 34F via one or more simultaneous or subsequent fabrication processes, such that the tab 26F extends from the second side of the body 30F. In these embodiments, the positioning of the tab 26F may separate the second arm 38F into portions 37F, 39F. Alternatively, the tab 26F may be coupled or affixed to the mounting device 4F proximate to the second arm 38F (and opposite the teeth 36F), such that the tab 26F may or may not separate the second arm 38F into portions 37F, 39F. In some embodiments, the tab 26F is aligned with the aperture 10F (e.g., where the tab 26F and the fastener 8 are both inserted into (or extend through) the same cutout 12 of the extension 14 of the MLPE 6).

In embodiments, the combination of the plurality of teeth 36F (e.g., on the first arm 34F) and the tab 26F prevents the rotation of the MLPE 6 relative to the PV frame 20 via the engagement of the mounting device 4F with the MLPE 6 and the PV frame 20, respectively (e.g., as illustrated in FIGS. 1C-1D). For example, preventing rotation is beneficial when the fastener 8 engages the threaded aperture 10F, during securing of the MLPE 6 to the PV frame 20 via engagement of the mounting device 4F to both the MLPE 6 and the PV frame 20.

The mounting device 4F includes a total length 40F, a total width 42F, and a tab height 44F. A center of the aperture 10F is positioned at an aperture length 46F and an aperture width 48F. The aperture length 46F may be measured from an outer edge 50F of the body 30F, while the aperture width 48F may be measured from a corner or bend 52F separating the body 30F from the second arm 38F. It is noted that the body 30F includes a second corner or bend 51F that separates the body 30F from the first arm 34F. The tab 26F includes a tab length 54F.

The neck 32F includes a neck height 56F. Optionally, the neck height 56F is sufficient for the neck 32F to receive at least 2.8 revolutions of the interior thread. In some non-limiting instances, the neck height 56F is sufficient to include at least four revolutions of the interior thread. As will be appreciated by one of skill in the art, increasing the number of thread revolutions improves the amount of pull-out force the fastener 8 can withstand before losing thread engagement with the mounting device 4F. It is noted that an extruded mounting device would require more material to make a body of increased thickness that is at least the neck height 56F, as compared to the neck 32F being a port formed via a series of fabrication operations (e.g., a series of progressive die processes, including stamping processes, punching processes, and bending processes, or the like), as described in detail further herein. In this regard, the mounting device 4F is not reliant on material thickness to ensure a sufficient amount of threading or thread revolutions within the neck 32F, as compared to an extruded mounting device with increased body thickness, such that the amount of material necessary to fabricate the mounting device 4F is reduced as compared to traditional mounting devices used in other metal panel (e.g., such as those used to form a roof) mounting applications.

The mounting device 4F has a first arm height 58F that is the height of the first arm 34F, and a second arm height 60F that is the height of the second arm 38F. In embodiments, the first arm height 58F is shorter than the second arm height 60F, where the difference in height is at least a thickness of the frame section 18 of the PV frame 20. The difference in the heights 58F, 60F beneficially accommodates differences in thicknesses of frame sections 18 produced by various manufacturers of PV frames 20. In one non-limiting example, the first arm 34F may come into contact with the first PV frame surface 22 of the frame section 18 and the second arm 38F may come into contact with an upper (or first) surface of the extension 14 of the MLPE device 6, due to the difference in arm heights 58F, 60F, when the fastener 8 is fully tightened within the mounting device 4F.

The first arm 34F is set at a first arm angle 62F relative to the body 30F. The second arm 38F is set at a second arm angle 64F relative to the body 30F. The tab 26 is set at a tab angle 66F relative to the body 30F. In general, the angles 62F, 64F, 66F may range from 0 degrees (°) to 180°. In some embodiments, the first arm height 58F and the second arm height 60F are less than the tab height 44F. The difference in the heights may be due to the angles of the arms 34F/38F versus the angle of the tab 26F relative to the body 30F.

In at least one embodiment, the first arm angle 62F is approximately 90° and the aperture axis is oriented at an axis angle of approximately 90° to the upper surface of the body such that the first arm 34F and the aperture axis are approximately parallel.

In some embodiments, the tab angle 66F is approximately 90° and the aperture axis is oriented at an axis angle of approximately 90° to the upper surface of the body such that the tab 26F and the aperture axis are approximately parallel.

In at least one embodiment, the first arm 34F, the tab 26F, and the aperture axis are approximately parallel.

In some non-limiting examples, the mounting device 4F is fabricated from a material having a thickness of about 0.059 inches (1.5 millimeters (mm)). The total length 40F is about 2.48 inches (63 mm), the total width 42F is about 1.34 inches (34 mm), and the tab height 44F is about 0.28 inches (7.0 mm). The aperture length 46F is about 1.24 inches (31.5 mm), and the aperture width 48F is about 0.39 inches (9.9 mm). The tab length 54F is about 0.31 inches (7.87 mm). The neck height 56F is about 0.14 inches (3.5 mm). The first arm height 58F is about 0.17 inches (4.32 mm), and the second arm height 60F is about 0.22 inches (5.59 mm).

The first arm angle 62F is between approximately 80° and 100° from the body 30F (or below a horizontal plane defined by a body surface 68F of the body 30F). In some embodiments, the first arm angle 62F is about 90°. In some non-limiting examples, the angle 62F being about 90° allows for an increased biting force to be applied by, and/or a reduced chance of slippage of the teeth 36F of the arm 34F onto/into the PV frame 20 (e.g., as illustrated in FIGS. 1A and 1C-1F), as compared to a smaller or shallower angle 62A, 62B, 62C as illustrated in FIGS. 2A-4H, respectively. It is noted the increased biting force may promote increased bonding and/or grounding between the PV frame 20 and the mounting device 4F. In other non-limiting examples, the angle 62F being about 90° allows for a reduced deflection of the body 30F following the tightening of the fastener 8, as compared to deflection of the body 30A, 30B, 30C that may be observed with a smaller or shallower angle 62A, 62B, 62C as illustrated in FIGS. 2A-4H, respectively.

The second arm angle 64F is between approximately 135° and 165° from the body 30F (or below the defined horizontal plane). In some embodiments, the second arm angle 64F is approximately 150° from the body 30F (or approximately 30° below the horizontal plane defined by the body surface 68F of the body 30F). The tab angle 66F is approximately 90° from the body 30F (or below the defined horizontal plane). The plurality of teeth 36F have a trough length 70F of about 0.138 inches (3.5 mm). The threading in the aperture 10F and the neck 32F is optionally M8×1.25 threading.

In some embodiments, the processes by which the mounting device 4F is formed using a progressive die includes the forming of the first arm 34F at approximately 90° to the body 30F (or approximately 90° below the horizontal plane defined by the body surface 68F). In addition, the processes by which the mounting device 4F is formed using a progressive die includes the forming of the second arm 38F and the tab 26F at approximately 150° relative to the body 30F (or approximately 30° below the horizontal plane defined by the body surface 68F). The processes by which the mounting device 4F is formed additionally includes a second process to further bend the tab 26F to about 90° below the body 30F (or the horizontal plane defined by the body surface 68F). As such, in some embodiments the portion of the first arm 34F with teeth 36F and the tab 26F are approximately parallel.

In some embodiments, the mounting device 4F is formed from a sheet of metal that has a substantially uniform thickness. Accordingly, in at least one embodiment, the body 30F, the first arm 34F, the second arm 38F, and the tab 26F have thicknesses that are substantially equal.

FIGS. 8A-8I illustrate a mounting device 4G, according to embodiments of the present disclosure. The features and function of the mounting device 4G are similar to those of the mounting devices 4, 4A, 4B, 4C, 4D, 4E, 4F. In particular, the mounting device 4G has features and dimensions that are the same as or similar to those of mounting device 4F. However, the mounting device 4G differs from the mounting devices 4, 4A, 4B, 4D, 4E, 4F in that there is no neck 32 or threading.

The mounting device 4G includes an aperture 10G and no neck or threading. The mounting device 4G includes a body 30G, and the aperture 10G is in the body 30G.

As illustrated in FIG. 8I, the PV system 2 requires a fastener receiver 72 for the fastener 8 due to the lack of threading of the aperture 10G. For example, where the fastener 8 is a bolt, the fastener receiver 72 may be a nut. Optionally, where the fastener 8 is threaded, a length of the fastener 8 that allows for at least 2.8 revolutions of the fastener receiver 72 onto the fastener 8 passes through and exits the mounting device 4G.

It is noted herein the mounting device 4G, the fastener 8, and the fastener receiver 72 may be considered components of the mounting system 3, for purposes of the present disclosure. In addition, it is noted herein that the fastener receiver 72 may be usable with the mounting devices 4, 4A, 4B, 4D, 4E, 4F as described throughout the present disclosure, as an additional amount of threading to further secure the fastener 8 within the respective mounting devices 4 (e.g., by causing binding or other interference between the respective neck 32 and the fastener receiver 72 should the fastener 8 attempt to disengage from the respective neck 32).

The mounting device 4G includes a first arm 34G extending from a first side of the body 30G. In some embodiments, the first arm 34F does not include teeth similar to the first arm 34D of mounting device 4D.

Alternatively, in other embodiments, a distal end of the first arm 34G optionally includes a plurality of teeth 36G, or other engaging features, that are operable to make contact with the frame section 18 (e.g., as illustrated in FIG. 1E). The plurality of teeth 36G may indent or cut (or “bite”) into the frame section 18 to increase the holding forces applied between the mounting device 4G and the PV frame 20 (e.g., as illustrated in FIG. 1E). Further, the teeth 36G may improve the electrical bonding (and the grounding path) between the frame section 18 of the PV frame 20 and the extension 14 of the MLPE 6.

The mounting device 4C includes a tab 26G extending from the body 30G. The mounting device 4G includes a second arm 38G extending from a second side of the body 30G. In some embodiments, the tab 26G is formed from a section of the second arm 38G via one or more simultaneous or subsequent fabrication processes, such that the tab 26G extends from the second side of the body 30G. In these embodiments, the positioning of the tab 26G may separate the second arm 38G into portions 37G, 39G. Alternatively, the tab 26G may be affixed to the mounting device 4G (e.g., proximate to the second arm 38G), such that the tab 26G may or may not separate the second arm 38G into portions 37G, 39G. In some embodiments, the tab 26G is aligned with the aperture 10G (e.g., where the tab 26G and the aperture 10G are inserted into the same cutout 12 of the extension 14 of the MLPE 6).

In embodiments, the combination of the plurality of teeth 36G (e.g., on the first arm 34G) and the tab 26G prevents the rotation of the MLPE 6 relative to the PV frame 20 via the engagement of the mounting device 4G with the MLPE 6 and the PV frame 20, respectively (e.g., as illustrated in FIGS. 1C-1D). For example, preventing rotation is beneficial when the fastener 8 passes through the aperture 10G, during securing of the MLPE 6 to the PV frame 20 via engagement of the mounting device 4G to both the MLPE 6 and the PV frame 20.

The mounting device 4G includes a total length 40G, a total width 42G, and a tab height 44G. A center of the aperture 10G is positioned at an aperture length 46G and an aperture width 48G. The aperture length 46G may be measured from an outer edge 50G, while the aperture width 48G may be measured from a corner 52G separating the body 30G from the second arm 38G. It is noted that the body 30G includes a second corner or bend 51G that separates the body 30G from the first arm 34G. The tab 26G includes a tab length 54G.

The mounting device 4G has a first arm height 58G that is the height of the first arm 34G, and a second arm height 60G that is the height of the second arm 38G. In embodiments, the first arm height 58G is shorter than the second arm height 60G, where the difference in height is at least a thickness of the frame section 18 of the PV frame 20. The difference in the heights 58G, 60G beneficially accommodates differences in thicknesses of frame sections 18 produced by various manufacturers of PV frames 20. In one non-limiting example, the first arm 34G may come into contact with the first PV frame surface 22 of the frame section 18 and the second arm 38G may come into contact with an upper (or first) surface of the extension 14 of the MLPE device 6, due to the difference in arm heights 58G, 60G, when the fastener 8 is fully tightened within the mounting device 4G.

The first arm 34G is set at a first arm angle 62G relative to the body 30G. The second arm 38G is set at a second arm angle 64G relative to the body 30G. The tab 26G is set at a tab angle 66G relative to the body 30G. In general, the angles 62G, 64G, 66G may range from 0° to 180°. In some embodiments, the first arm height 58G and the second arm height 60G are less than the tab height 44G. The difference in the heights may be due to the angles of the arms 34G/38G versus the angle of the tab 26G relative to the body 30G.

In some non-limiting examples, the mounting device 4G is fabricated from a material having a thickness of about 0.059 inches (1.5 millimeters (mm)). The total length 40G is about 2.48 inches (63 mm), the total width 42G is about 1.34 inches (34 mm), and the tab height 44G is about 0.28 inches (7.0 mm). The aperture length 46G is about 1.24 inches (31.5 mm), and the aperture width 48G is about 0.39 inches (9.9 mm). The tab length 54G is about 0.31 inches (7.87 mm). The first arm height 58G is about 0.17 inches (4.32 mm), and the second arm height 60G is about 0.22 inches (5.59 mm).

The first arm angle 62G is between approximately 80° and 100° from the body 30G (or below a horizontal plane defined by a body surface 68G of the body 30G). In some embodiments, the first arm angle 62G is about 90°. In some non-limiting examples, the angle 62G being about 90° allows for an increased biting force to be applied by, and/or a reduced chance of slippage of, the teeth 36G of the arm 34G onto/into the PV frame 20 (e.g., as illustrated in FIGS. 1A and 1C-1F), as compared to a smaller or shallower angle 62A, 62B, 62C as illustrated in FIGS. 2A-4H, respectively. It is noted the increased biting force may promote increased bonding and/or grounding between the PV frame 20 and the mounting device 4G. In other non-limiting examples, the angle 62G being about 90° allows for a reduced deflection of the body 30G following the tightening of the fastener 8, as compared to deflection of the body 30A, 30B, 30C that may be observed with a smaller or shallower angle 62A, 62B, 62C as illustrated in FIGS. 2A-4H, respectively.

The second arm angle 64G is between approximately 135° and 165° from the body 30G (or below the defined horizontal plane). In some embodiments, the second arm angle 64G is approximately 150°. The tab angle 66G is approximately 90° from the body 30G (or below the defined horizontal plane). The plurality of teeth 36G have a trough length 70G of about 0.138 inches (3.5 mm).

In some embodiments, the processes by which the mounting device 4G is formed using a progressive die includes the forming of the first arm 34G at approximately 90° to the body 30G (or approximately 90° below the horizontal plane defined by the body surface 68G). In addition, the processes by which the mounting device 4G is formed using a progressive die includes the forming of the second arm 38G and the tab 26G at approximately 150° relative to the body 30G (or approximately 30° below the horizontal plane defined by the body surface 68G). The processes by which the mounting device 4G is formed additionally includes a second process to further bend the tab 26G to about 90° below the body 30G (or the horizontal plane defined by the body surface 68G). As such, in some embodiments the portion of the first arm 34G with teeth 36G and the tab 26G are approximately parallel.

In some embodiments, the mounting device 4G is formed from a sheet of metal that has a substantially uniform thickness. Accordingly, in at least one embodiment, the body 30G, the first arm 34G, the second arm 38G, and the tab 26G have thicknesses that are substantially equal.

Although not shown, it should be understood that the various angles for the respective tabs 26, first arm 34, and second arms 38 of the mounting devices 4, 4A, 4B, 4C, 4D, 4E, 4F, 4G may be combinable, without departing from the scope of the present disclosure. In one non-limiting example, the respective first arm 34 may have a respective first arm angle 62 of approximately 135° to the respective body 30 (or approximately 45° below the horizontal plane defined by the respective body surface 68 of the respective body 30). In addition, the respective second arm 38 may have a respective second arm angle 64 of approximately 150° relative to the respective body 30 (or approximately 30° below the horizontal plane defined by the respective body surface 68 of the respective body 30). Further, the respective tab 26 may have a respective tab angle 66 of approximately 90° below the respective body 30 (or the horizontal plane defined by the respective body surface 68 of the respective body 30). In general, the respective angles 62, 64, 66 may be any angle desirable by a manufacturer, fabricator, or consumer to secure a MLPE 6 to a PV frame 20, including with or without contact of the respective second arm 38 to the extension 14 of the MLPE 6, without departing from the scope of the present disclosure.

Referring in general to FIGS. 1A-8I, in embodiments the mounting devices 4, 4A, 4B, 4C, 4D, 4E, 4F, 4G are fabricated from a metal including, but not limited to, steel, stainless steel, or the like. For example, the metal may be 304SS or another stainless steel in the 304xx or 316xx families of stainless steels. In general, the metal from which the mounting devices 4, 4A, 4B, 4C, 4D, 4E, 4F, 4G are fabricated may be any metal that provides increased corrosion resistance, as well as increased strength (e.g., as compared to some aluminum materials traditionally used for extrusion) to more easily cut or otherwise pierce an anodization layer (i.e., via the teeth 36) on the first PV frame surface 22 of the PV frame 20 for bonding and/or grounding between the mounting device 4 and the PV frame 20, as illustrated in FIGS. 1A-1F.

In embodiments, the mounting devices 4, 4A, 4B, 4C, 4D, 4E, 4F, 4G are fabricated using a series of processes through a progressive die. In some non-limiting examples, a coil roll is run through the progressive die that simultaneously forms between 2 and 8 mounting devices 4, 4A, 4B, 4C, 4D, 4E, 4F, 4G via 4-10 fabrication processes that are performed simultaneously, substantially simultaneously, or sequentially. For instance, the fabrication processes performed by (or within) the progressive die may include, but are not limited to, stamping processes, necking processes, punching processes, bending processes, and/or tapping processes. It should be understood that any reference throughout the present disclosure to fabrication processes that may be performed using a progressive die to manufacture the mounting devices 4, 4A, 4B, 4C, 4D, 4E, 4F, 4G are not intended to be limiting with respect to order, and that other orders for the processes may exist without departing from the scope of the present disclosure.

In this regard, the mounting devices 4, 4A, 4B, 4C, 4D, 4E, 4F, 4G should be understood as differing from known mounting devices (e.g., for PV or other metal panel (e.g., such as those used to form a roof) mounting applications) in a number of non-limiting ways. First, the stainless steel or other increased corrosion resistance and higher-strength material from which the mounting devices 4, 4A, 4B, 4C, 4D, 4E, 4F, 4G are fabricated should be understood as differing from the traditional aluminum used for mounting devices in other metal panel (e.g., such as those used to form a roof) mounting applications. Second, the formation of the mounting devices 4, 4A, 4B, 4C, 4D, 4E, 4F, 4G differs via a series of processes through a progressive die as compared to the traditional extrusion processes that are used to fabricate mounting devices in other metal panel (e.g., such as those used to form a roof) mounting applications. This results in the need for less material needed per mounting device, and potentially results in less manufacturing or fabrication costs.

In addition, it should be understood that the mounting devices 4, 4A, 4B, 4C, 4D, 4E, 4F, 4G may be considered to be devices with a single-piece configuration that is able to receive a fastener (e.g., to form a mounting device assembly), and that has optional engagement features including the respective first arm 34 (e.g., with the plurality of teeth 36), the second arm 38, and the tab 26 that are formed as portions of the single-piece configuration through the progressive die fabrication processes. The single-piece configuration does not utilize or require external or secondary processes to create apertures into which additional engagement features are installed (e.g., threaded, pressed, or the like).

In embodiments, installation of the mounting devices 4, 4A, 4B, 4C, 4D, 4E, 4F, 4G on a metal panel (e.g., that forms a roof surface) includes one or more of the following processes. It should be understood that the following processes are not intended to be limiting with respect to order, and that other orders for the processes may exist without departing from the scope of the present disclosure.

A mounting device 4, 4A, 4B, 4C, 4D, 4E, 4F, 4G is coupled to the MLPE 6 (e.g., as illustrated in FIGS. 1A-1F). For example, the mounting device 4, 4A, 4B, 4C, 4D, 4E, 4F, 4G may be coupled to the extension 14 of the MLPE 6. For instance, a fastener 8 is inserted into the cutout or slot 12 of the extension 14 of the MLPE 6 from a first direction relative to a first surface of the extension 14 of the MLPE 6, to engage the respective aperture 10 (e.g., within the optional respective neck 32) of the mounting device 4, 4A, 4B, 4C, 4D, 4E, 4F, 4G positioned proximate to a second, opposite surface of the extension 14 of the MLPE 6. In addition, where the mounting device 4, 4A, 4B, 4C, 4D, 4E, 4F, 4G includes the optional respective tab 26, the respective tab 26 should be nearly (or completely) fully inserted into the cutout or slot 12 within the extension 14 of the MLPE 6 at a predetermined (e.g., maximum) depth of the cutout or slot 12. It is noted that the respective tab 26 may engage the cutout or slot 12 from a second direction relative to the second, opposite surface of the extension 14 of the MLPE 6.

The assembly including the MLPE 6, the fastener 8, and the mounting device 4, 4A, 4B, 4C, 4D, 4E, 4F, 4G are coupled to the PV frame 20. In some non-limiting examples, the fastener 8 is initially installed at a first tightness (e.g., with a first amount of torque) to leave a gap 16 between the mounting device 4, 4A, 4B, 4C, 4D, 4E, 4F, 4G and the extension 14 of the MLPE 6. The assembly of the MLPE 6, the fastener 8, and the mounting devices 4, 4A, 4B, 4C, 4D, 4E, 4F, 4G is then coupled to the PV frame 20 by a frame section 18 of the PV frame 20 being inserted into the gap 16.

At least with respect to the mounting devices 4C and 4G, where the respective aperture 10 is not threaded (and/or where there may not be a respective neck 32), an additional positioning of a fastener receiver 72 (e.g., a nut, or the like) proximate to the respective aperture 10 occurs, and the fastener 8 passes through the respective aperture 10 to engage the fastener receiver 72. It is noted that any assembly may additionally utilize the fastener receiver 72, without departing from the scope of the present disclosure.

The assembly of the MLPE 6, the fastener 8, and the mounting device 4, 4A, 4B, 4C, 4D, 4E, 4F, 4G is secured to the PV frame 20. In some non-limiting examples, the fastener 8 is tightened to a second tightness (e.g., with a second amount of torque) to cause the respective first arm 34 (with optional plurality of teeth 36) to draw against the first PV frame surface 22, and the extension 14 of the MLPE 6 to draw against the second PV frame surface 24. For instance, the optional respective plurality of teeth 36 may cut into the anodized layer on the first PV frame surface 22, to promote increased levels of bonding and grounding between the mounting devices 4, 4A, 4B, 4C, 4D, 4E, 4F, 4G, the MLPE 6, and the PV frame 20. Optionally, the respective second arm 38 may draw against the extension 14 of the MLPE 6. In some instances, the second amount of torque may range between approximately 85 and 155 inch-pounds of torque, and preferably be approximately 115 inch-pounds of torque.

The mounting devices of all embodiments described herein provide many benefits compared to known mounting devices. For example, the mounting devices of the present disclosure are less expensive to manufacture than comparable mounting devices that are known. The mounting devices of the present disclosure are also simpler to install, and can be installed more quickly, than known mounting devices configured to engage and secure MLPE to PV frames.

Another benefit of the mounting devices of the present disclosure is that the mounting devices are designed and configured to engage an MLPE and/or a PV frame in such a way that the mounting devices do not inhibit the solar panels installed above the MLPE within the PV frame. Said differently, the mounting devices of the present disclosure are designed to accommodate both the spacing necessary for the MLPE and the solar panel. This is especially important, to provide a clean and more compact PV system build.

Further, the mounting devices of the present disclosure are low profile, which is beneficial for positioning the MLPE device within PV systems. Traditional PV systems require the MLPE device to be mounted at pre-determined locations that are not constrained by height restrictions, where the locations are defined by pre-punched or pre-cut apertures (e.g., in the PV frame). The low profile of the mounting devices of the present disclosure, however, allow the MLPE device to be positioned within the PV system anywhere on the PV frame, increasing the utility of the direct attach features provided with the mounting device and engaging fastener and increasing the adaptability of the PV system to various building surfaces or racks.

While various embodiments of the system and method have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items. Further, it is to be understood that the claims is not necessarily limited to the specific features or steps described herein. Rather, the specific features and steps are disclosed as embodiments of implementing the claimed systems and methods.

One aspect of the disclosure comprises any one or more of the aspects/embodiments as substantially disclosed herein.

Another aspect of the disclosure is any one or more of the aspects/embodiments as substantially disclosed herein optionally in combination with any one or more other aspects/embodiments as substantially disclosed herein.

It is another aspect of the present disclosure to provide one or more means adapted to perform any one or more of the above aspects/embodiments as substantially disclosed herein.

What is claimed is:

1. A mounting device that is selectively engageable to a component of a photovoltaic system, the mounting device comprising:
a body including an aperture operable to receive a fastener that is able to engage an extension of the component, wherein the aperture extends through a neck extending from a surface of the body, and wherein the aperture is at least partially threaded with interior threading that corresponds to exterior threading on at least a portion of a shaft of the fastener;
a first arm extending from a first side of the body, the first arm including a plurality of teeth, the first arm extending at a first arm angle relative to the surface of the body;
a second arm extending from a second side of the body, the second arm extending at a second arm angle relative to the surface of the body; and
a tab extending at a tab angle relative to the surface of the body, wherein the tab is operable to engage a cutout through the extension of the component,
wherein, when the aperture receives the fastener, the plurality of teeth of the first arm is operable to make contact with a first surface of a frame section of a photovoltaic (PV) frame of the photovoltaic system and hold the extension of the component against a second surface of the frame section, securing the PV frame within a gap defined between the first arm and the extension of the component.

2. The mounting device of claim 1, wherein the tab extends from the second side of the body and is formed from a section of the second arm.

3. The mounting device of claim 2, wherein the second arm is separated into first and second portions by the tab.

4. The mounting device of claim 1, wherein the tab angle is different from one or more of the first arm angle and the second arm angle.

5. The mounting device of claim 4, wherein the tab angle and the first arm angle are such that the tab and the first arm are approximately parallel, and wherein the second arm angle is different from the tab angle and the first arm angle.

6. The mounting device of claim 4, wherein the tab angle is less than one or more of the first arm angle and the second arm angle.

7. The mounting device of claim 6, wherein:
the tab angle is approximately 90 degrees;
the first arm angle is between 85 degrees and 140 degrees; and
the second arm angle is between 125 degrees and 160 degrees.

8. The mounting device of claim 7, wherein:
the tab angle is approximately 90 degrees;
the first arm angle is approximately 90 degrees; and
the second arm angle is approximately 150 degrees.

9. The mounting device of claim 6, wherein:
the tab angle is approximately 90 degrees;
the first arm angle is between 85 degrees and 140 degrees; and
the second arm angle is between 85 degrees and 140 degrees.

10. The mounting device of claim 9, wherein:
the tab angle is approximately 90 degrees;
the first arm angle is approximately 135 degrees; and
the second arm angle is approximately 135 degrees.

11. The mounting device of claim 1, wherein the PV frame is secured within the gap defined between the first arm and the extension of the component when the aperture receives the fastener.

12. The mounting device of claim 1, wherein the component is a module-level power electronics device (MLPE).

13. A mounting system that is selectively engageable to a photovoltaic (PV) frame and a component of a photovoltaic system, the mounting system comprising:
a fastener including a head and a shaft, wherein the fastener is able to engage an extension of the component; and
a bracket, comprising:
a body including an aperture operable to receive the shaft of the fastener;
a first arm extending from a first side of the body, the first arm including a plurality of teeth, the first arm extending at a first arm angle relative to a surface of the body; and
a second arm extending from a second side of the body, the second arm extending at a second arm angle relative to the surface of the body,
wherein, when the aperture receives the shaft of the fastener, the first arm is operable to make contact with a first surface of a frame section of the PV frame and hold the extension of the component against a second surface of the frame section, securing the PV frame within a gap defined between the first arm and the extension of the component.

14. The mounting system of claim 13, wherein the aperture extends through a neck extending from the surface of the body.

15. The mounting system of claim 14, wherein the aperture is at least partially threaded with interior threading that corresponds to exterior threading on at least a portion of the shaft of the fastener, and wherein the aperture extends along an aperture axis that is approximately perpendicular to the surface of the body.

16. The mounting system of claim 13, wherein the first arm angle is approximately 90°.

17. The mounting system of claim 13, wherein the bracket further comprises a tab extending at a tab angle relative to the surface of the body, and wherein the tab is operable to engage a cutout in the extension of the component.

18. The mounting system of claim 13, further comprising:
a nut including interior threading that corresponds to exterior threading on at least a portion of the shaft of the fastener,
wherein the PV frame is secured within the gap defined between the first arm and the extension of the component when the nut is threaded onto the fastener after the shaft of the fastener extends through the aperture and a cutout in the extension of the component.

19. The mounting system of claim 13, wherein the component is a module-level power electronics device (MLPE).

20. A photovoltaic (PV) system, comprising:
a PV frame operable to receive a solar panel, wherein the PV frame includes a frame section;
a module-level power electronics device (MLPE), wherein the MLPE includes an extension with a cutout;
a fastener including a head and a shaft, wherein the shaft is able to extend through the cutout of the extension of the MLPE; and
a bracket, comprising:
a body including an aperture operable to receive the shaft of the fastener;
a first arm extending from a first side of the body, the first arm extending at a first arm angle relative to a surface of the body; and
a second arm extending from a second side of the body, the second arm extending at a second arm angle relative to the surface of the body,
wherein, when the shaft extends through the cutout and the aperture receives the shaft, the first arm is operable to make contact with a first surface of the frame section of the PV frame and hold the extension of the MLPE against a second surface of the frame section of the PV frame, securing the PV frame to the extension of the MLPE and electrically bonding the frame section and the MLPE.
